(19) United States
(12) Patent Application Publication
(10) Pub. No.: US 2026/0370318 A1
(43) Pub. Date: Nov. 19, 2026

(54) Message Relay in Satellite-Based Communications Networks

(71) Applicant: Apple Inc., Cupertino, CA (US)

(72) Inventors: Gregory R Nelson, Los Altos, CA (US); Abhishek Walia, Santa Clara, CA (US); Aditya Chaturvedi, Santa Clara, CA (US); Jialin Song, Cupertino, CA (US)

(21) Appl. No.: 19/208,498

(22) Filed: May 14, 2025

(51) Int. Cl. H04B 7/185; H04W 4/14; H04W 8/20; H04W 12/03; H04W 28/06

(52) U.S. Cl. CPC H04B 7/18539; H04W 4/14; H04W 8/20; H04W 12/03; H04W 28/06

(57) ABSTRACT

A communications system may include a core network (CN) that communicates with a first UE and a second UE associated with the same user. When the first and second UE are both on-grid with a terrestrial network, the first UE may convey messages with a third UE via relay by the second UE and a carrier network using a subscriber identity module (SIM) of the second UE. When the first UE moves off-grid, the first UE may connect to the CN via a constellation of satellites. The first UE may convey messages with the third UE via the constellation, the CN, and relay by the second UE using the SIM of the second UE. In this way, the user may maintain messaging capabilities with the third UE while using the first UE off-grid, without requiring an additional SIM for the first UE.

### FIELD

This relates generally to wireless communications, including wireless communications by electronic devices.

### BACKGROUND

Communications systems are used to convey data between terminals such as user equipment (UE) devices. Some communications systems include satellites that wirelessly convey data between user UE devices and gateways. It can be challenging to ensure that these types of communications systems are able to exhibit satisfactory performance across a wide range of operating conditions.

### SUMMARY

A communications system may include a core network (CN) that communicates with user equipment (UE) devices. The UE devices may include at least a first UE device and a second UE device associated with the same user. When the first UE device and the second UE device are both on-grid with a terrestrial network, the first UE device may convey messages with a third UE device. The first UE device may convey the messages with the second UE device over a UE-to-UE link. The second UE device may relay the messages between the first and third UE devices via a carrier network and using a subscriber identity module (SIM) of the carrier network on the second UE device.

When the first UE device moves off-grid, the first UE device may connect to the CN via a constellation of communication satellites. The first UE device may transmit Mobile Originated (MO) messages destined for the third UE device to the CN via the constellation. The CN may forward the MO messages to the second UE device over the terrestrial network. The second UE device may use its SIM to relay the MO messages to the third UE device via the carrier network. The second UE device may transmit a relay confirmation message to the first UE device via the core network and the constellation. Additionally, or alternatively, the third UE device may transmit Mobile Terminated (MT) messages to the second UE device via the carrier network. The second UE device may relay the MT messages to the first UE device via the core network and the constellation. The first UE device may transmit a delivery receipt to the second UE device via the constellation and the core network. In this way, the user of the first and second UE devices may maintain messaging capabilities with the third UE device while using the first UE device off-grid, without requiring an additional SIM for the first UE device.

An aspect of the disclosure provides a method of operating a first user equipment (UE) device. The method can include connecting to a core network via a constellation of communication satellites. The method can include transmitting a message to a second UE device via the constellation, the core network, and relay by a third UE device that is associated with the first UE device. The message can include a handle associated with a subscriber identity module (SIM) of the third UE device. The message can include a destination address associated with the second UE device.

An aspect of the disclosure provides a method of operating a first user equipment (UE) device. The method can include receiving, from a core network, a message that was transmitted by a second UE device to the core network over a constellation of communication satellites. The method can include relaying, using a subscriber identity module (SIM) of the first UE device, the message to a third UE device via a wireless base station and a carrier network, the carrier network being associated with the SIM of the first UE device.

An aspect of the disclosure provides a method of operating one or more servers of a core network. The method can include receiving a message from a first user equipment (UE) device via a constellation of communications satellites, wherein software on the first UE device is logged into an account associated with the core network. The method can include forwarding the message to a second UE device via a terrestrial network, wherein software on the second UE device is logged into the account associated with the core network. The method can include receiving a relay confirmation message from the second UE device via the terrestrial network, wherein the relay confirmation message is indicative of the second UE device relaying the message to a third UE device that is different from the first and second UE devices.

### BRIEF DESCRIPTION OF THE DRAWINGS

FIG. 1 is a diagram of an illustrative communications system including a first user equipment device that serves as a relay between a second user equipment device and a third user equipment device for communications via a constellation of communications satellites in accordance with some embodiments.

FIG. 2 is a schematic diagram of an illustrative user equipment device in accordance with some embodiments.

FIG. 3 is a schematic diagram of an illustrative communications satellite in accordance with some embodiments.

FIG. 4 is a schematic diagram of an illustrative core network in accordance with some embodiments.

FIG. 5 is a flow chart of illustrative operations that may be performed by first and second user equipment devices to convey messages with a third user equipment device via a constellation of communications satellites in accordance with some embodiments.

FIG. 6 is a timing diagram showing how illustrative messages may be relayed by a first user equipment device between a second and third user equipment devices over a constellation of communications satellites and a terrestrial network in accordance with some embodiments.

FIG. 7 is a timing diagram of an illustrative satellite messaging service initialization procedure that may be performed by a user equipment device and a core network in accordance with some embodiments.

FIG. 8 is a timing diagram showing how an illustrative off-grid user equipment device may transmit a message to another user equipment device via relay by an associated on-grid user equipment device in accordance with some embodiments.

FIG. 9 is a timing diagram showing how an illustrative off-grid user equipment device may receive a message from another user equipment device via relay by an associated on-grid user equipment device in accordance with some embodiments.

### DETAILED DESCRIPTION

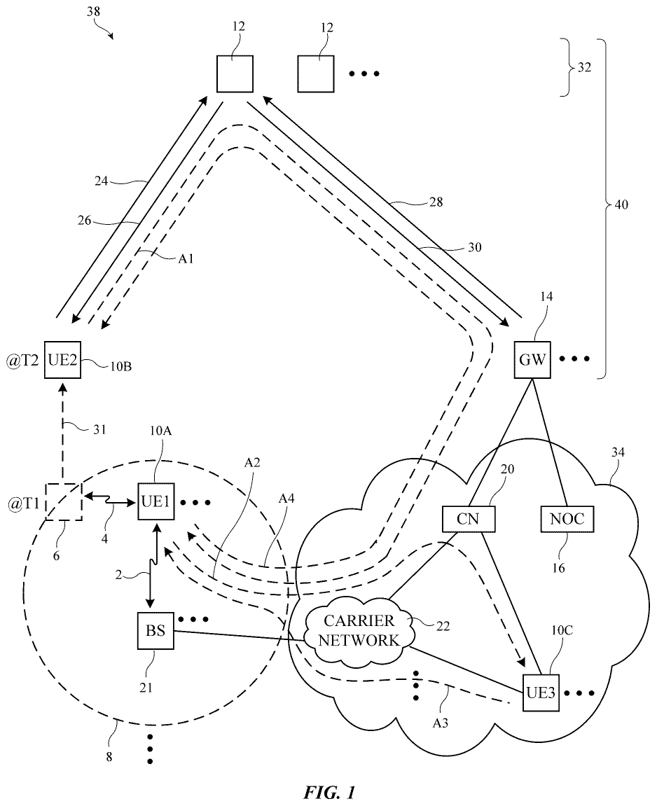

FIG. 1 is a diagram of an illustrative communications system 38. Communications system 38 (sometimes referred to herein as communications network 38, network 38, system 38, satellite communications system 38, or satellite communications network 38) may include a first network having a first maximum bandwidth such as terrestrial network 34. Communications system 38 may also include a second network having a second maximum bandwidth less than the first maximum bandwidth such as non-terrestrial network (NTN) 40.

Communications system 38 may include a set of one or more user equipment (UE) devices 10 on Earth, such as at least a first UE device 10A (sometimes denoted herein as UE1), a second UE device 10B (sometimes denoted herein as UE2), and a third UE device 10C (sometimes denoted herein as UE3). Only three UE devices are illustrated in FIG. 1 for the sake of simplicity and clarity. In general, communications system 38 may include any desired number of UE devices (e.g., hundreds, thousands, millions, billions, etc.).

The nodes, hosts, terminals, and devices of terrestrial network 34 are located on Earth. NTN 40 is a space-based network that includes nodes, hosts, terminals, and/or devices on Earth as well as in space (e.g., in orbit around Earth). NTN 40 may include a ground-based (terrestrial) gateway system that includes one or more gateways 14. NTN 40 may also include a set of one or more UE devices 10 (e.g., UE devices configured to communicate via NTN 40) such as UE device 10B and optionally UE device 10A. Terrestrial network 34 may include a set of one or more UE devices 10 such as UE device 10C. UE device 10A and/or UE device 10B may form part of terrestrial network 34 when the UE devices communicate with terrestrial-based wireless communications equipment 21 (sometimes also referred to herein as terrestrial-based communications equipment 21 or terrestrial communications equipment 21). Although illustrated outside of terrestrial network 34 in FIG. 1 for the sake of clarity, wireless communications equipment 21 forms a part of terrestrial network 34 and may, if desired, form a part of a corresponding carrier network 22.

Terrestrial network 34 may include a set of one or more different worldwide cellular telephone carrier networks such as carrier network 22. Carrier network 22 is sometimes also referred to herein as cellular network 22, cellular carrier network 22, or cellular telephone carrier network 22. Carrier network 22 may be associated with, operated by, owned by, controlled by, and/or managed by a corresponding cellular telephone network carrier or service provider (sometimes also referred to as a mobile network operator (MNO)). Carrier network 22 may include a respective network of cellular base stations. Each cellular base station may provide cellular telephone coverage within a respective geographic region or area, sometimes also referred to as a cell. The cellular base stations of carrier network 22 may convey radio-frequency signals with UE devices 10 in one or more cellular telephone communications bands, using one or more cellular telephone radio access technologies (RATs), and using one or more cellular telephone communications protocols. The radio-frequency signals may convey wireless data such as voice data, cellular data, and Short Messaging Service (SMS) text messages. Each UE device 10 of a corresponding carrier network 22 (e.g., UE devices 10 registered with or subscribed to the carrier network) may include a subscriber identity module (SIM) (e.g., a SIM card) associated with the carrier network and/or the MNO of the carrier network.

In some implementations that are described herein as an example, wireless communications equipment 21 may be a cellular base station (BS) of carrier network 22 (e.g., a gNB of carrier network 22). Wireless communications equipment 21 is therefore sometimes also referred to herein as BS 21. This example is illustrative and non-limiting and, in other implementations, wireless communications equipment 21 (sometimes also referred to herein as terrestrial-based wireless communications equipment 21) may be a wireless access point (AP) (e.g., of a wireless local area network), another UE device, and/or any other desired wireless equipment. Wireless communications equipment 21 may have a corresponding coverage area (cell) 8. Wireless communications equipment 21 may convey radio-frequency signals with UE devices 10 that are located within its coverage area 8 (e.g., at a threshold signal level or higher).

While within coverage area 8, UE device 10A may convey radio-frequency signals with BS 21 over a corresponding terrestrial network wireless communication link 2 when available. UE device 10A may convey wireless data (e.g., text messages, voice data, other cellular data, etc.) over terrestrial network wireless communication link 2 using radio-frequency signals conveyed between UE device 10A and BS 21. Terrestrial network wireless communication link 2 may be supported using cellular telephone signals, WLAN signals, WPAN signals, device-to-device (D2D) signals (e.g., peer-to-peer (P2P) signals or client-to-client (C2C) signals), etc. In other words, terrestrial network wireless communication link 2 may be a cellular telephone link, a WLAN link (e.g., a Wi-Fi link), a WPAN link (e.g., a Bluetooth link or an Ultra-Low Latency Audio link), a D2D link (e.g., a P2P or C2C link), etc. Implementations in which terrestrial network wireless communication link 2 is a cellular telephone link with BS 21 are described herein as a non-limiting example (e.g., BS 21 may be replaced with a UE device or an AP in any of the implementations described herein).

A UE device 10 is referred to herein as being “online” or “on-grid” when the UE device is within range of terrestrial-based wireless communications equipment 21 and when terrestrial-based wireless communications equipment 21 provides access (e.g., communications resources) to terrestrial network 34 for the UE device. When the UE device is on-grid, the UE device may communicate with other network nodes or terminals of terrestrial network 34 via terrestrial network wireless communications link 2. In the example of FIG. 1, UE device 10A is an on-grid UE device. In addition, at a first time T1, UE device 10B may be at a location 6 that is within coverage area 8 of BS 21. As such, UE device 10B may also be on-grid at time T1 (e.g., at location 6).

Conversely, a UE device 10 is referred to herein as being “offline” or “off-grid” when the UE device is out of range of any wireless communications equipment of terrestrial network 34 such as BS 21 (e.g., such that a wireless performance metric characterizing communications between the UE device and the terrestrial-based wireless communications equipment is less than a threshold level), or when the UE device is in range of wireless communications equipment of terrestrial network 34 (e.g., BS 21) but the wireless communications equipment does not provide the UE device with access to terrestrial network 34. In-range wireless communications equipment (e.g., BS 21) may not provide access to terrestrial network 34 for a UE device in its coverage area 8 (rendering the UE device off-grid) when, for example, the in-range wireless communications equipment is disabled due to a power outage, natural disaster, traffic surge, or emergency, when the in-range wireless communications equipment denies access to terrestrial network 34 for the UE device, when the in-range wireless communications equipment is overloaded with other communications traffic, etc. A UE device is sometimes referred to herein as being connected to terrestrial network 34 (e.g., via terrestrial network wireless communications link 2) while on-grid. A UE device is sometimes referred to herein as being disconnected or unconnected from terrestrial network 34 while off-grid.

Communications system 38 may include a constellation 32 of one or more communications satellites 12. UE devices 10, gateways 14, and constellation 32 may form a part of NTN 40 that conveys signals between UE devices 10 and gateways 14 via constellation 32. Constellation 32 is sometimes also referred to herein as satellite constellation 32. Communications satellites 12 are sometimes also referred to herein simply as satellites 12. Satellites 12 are located in space (e.g., in orbit around Earth). Communications system 38 may include any desired number of gateways 14, any desired number of satellites 12, and any desired number of UE devices 10. Only a single gateway 14, two satellites 12, and three UE devices 10 are illustrated in FIG. 1 for the sake of simplicity. Each gateway 14 in communications system 38 may be located at a different respective geographic location on Earth (e.g., across different regions, cities, counties, prefectures, districts, municipalities, land masses, areas, localities, states, provinces, countries, continents, etc.).

Terrestrial network 34 (sometimes also referred to herein as network portion 34 or simply as network 34) may be communicatively coupled to each of the gateways 14 in communications system 38. A gateway (GW) 14 may include a satellite network ground station and is therefore sometimes also referred to as a ground station (GS) 14 or satellite network ground station 14. Each gateway 14 may include one or more electronic devices (e.g., servers, network racks, desktop computers, laptop computers, other network devices, etc.) that interface between constellation 32 and terrestrial network 34. Each gateway 14 may also include wireless equipment communicatively coupled to the device(s). The wireless equipment may include antennas (e.g., electronically and/or mechanically adjustable antennas), modems, transceivers, amplifiers, beam forming circuitry, software defined radios, hardware radios, control circuitry (e.g., one or more processors, storage circuitry, etc.), and other components that are used to convey communications data. The devices and components of a given gateway 14 may, for example, be disposed at a corresponding geographic location (e.g., within the same computer, server, data center, building, etc.). Gateways 14 may convey communications data between terrestrial network 34 and UE devices 10 via constellation 32 (e.g., gateways 14 may serve as an interface between NTN 33 and terrestrial network 34).

Terrestrial network 34 may include any desired number of network nodes (e.g., terminals, devices, end hosts, etc.) that are communicatively coupled together using communications paths that include wired and/or wireless links. The wired links may include cables (e.g., ethernet cables, optical fibers or other optical cables that convey signals using light, telephone cables, radio-frequency cables such as coaxial cables or other radio-frequency transmission lines, radio-frequency connectors, optical connectors, components that convert signals between optical and electrical signals, etc.). Network portion 18 may include one or more relay networks, mesh networks, local area networks (LANs), wireless local area networks (WLANs), ring networks (e.g., optical rings), cloud networks, virtual/logical networks, the Internet, combinations of these, and/or any other desired network nodes coupled together using any desired network topologies (e.g., on Earth). The network nodes, terminals, and/or end hosts may include network switches, network routers, optical add-drop multiplexers, other multiplexers, repeaters, modems, servers, network cards, wireless access points, wireless base stations, UE devices such as UE devices 10 (e.g., at least UE device 10C in the illustrative deployment shown in FIG. 1), and/or any other desired network components. The network nodes in terrestrial network 34 may include physical components such as electronic devices, servers, computers, user equipment, etc., and/or may include virtual components that are logically defined in software and that are distributed across (over) two or more underlying physical devices (e.g., in a cloud network configuration).

Terrestrial network 34 may include one or more satellite network operations centers such as network operations center (NOC) 16. NOC 16 may control the operation of gateways 14 in communicating with constellation 32 and/or may control the operation of the satellites in constellation 32. For example, NOC 16 may generate and transmit control commands via gateways 14 that control positioning operations (e.g., orbit adjustments, rotations, etc.), payload deployment operations, sensing operations (e.g., thermal information gathered using one or more thermal sensors), and/or any other desired operations performed in space by satellites 12. NOC 16, gateways 14, and constellation 32 may be operated or managed by a corresponding satellite constellation operator.

Communications system 38 may also include a satellite communications (satcom) network service provider (e.g., a satcom network carrier or operator) for controlling wireless communications between UE devices 10 and terrestrial network 34 via constellation 32. The satcom network service provider may be a different entity than the satellite constellation operator that controls/operates NOC 16, gateways 14, and constellation 32, or may be the same entity as the satellite constellation operator. The cellular telephone network service provider associated with carrier network 22 may be a different entity than the satcom network service provider or, if desired, may be the same entity as the satcom network service provider.

One or more gateways 14 may control the operations of constellation 32 over corresponding radio-frequency communications links. Constellation 32 may include any desired number of satellites (e.g., two satellites, four satellites, ten satellites, dozens of satellites, hundreds of satellites, thousands of satellites, etc.), two of which are shown in FIG. 1. If desired, two or more of the satellites in constellation 32 may convey radio-frequency signals between each other using satellite-to-satellite (e.g., in-space relay) links.

The satellites 12 in constellation 32 may include a set of one or more non-geostationary orbit (NGSO) satellites 12 (e.g., satellites in non-geostationary orbits) and, if desired, may include a set of one or more geostationary orbit (GSO) satellites 12 (e.g., satellites in geostationary/geosynchronous orbits, sometimes referred to as geosynchronous satellites or GEO satellites). GSO satellites in constellation 32 may orbit Earth at orbital altitudes of greater than around 30,000 km. NGSO satellites in constellation 32 may include low earth orbit (LEO) satellites at orbital altitudes of less than around 8,000 km (e.g., satellites in low earth orbits, inclined low earth orbits, low earth circular orbits, etc.), medium earth orbit (MEO) satellites at orbital altitudes between around 8,000 km and 30,000 km (e.g., satellites in medium earth orbits), sun synchronous satellites (e.g., satellites in sun synchronous orbits), satellites in tundra orbits, satellites in Molniya orbits, satellites in polar orbits, and/or satellites in any other desired non-geosynchronous orbits around Earth. If desired, satellites 12 may include multiple sets of satellites each in a different type of orbit, orbital plane, and/or orbital altitude. In general, constellation 32 may include satellites in any desired combination of orbits or orbit types.

The satellites 12 in constellation 32 may communicate with one or more UE devices 10 on Earth using one or more radio-frequency communications links (e.g., satellite-to-user equipment links). Satellites 12 may also communicate with gateways 14 on Earth using radio-frequency communications links (e.g., satellite-to-gateway links). Radio-frequency signals may be conveyed between UE devices 10 and satellites 12 and between satellites 12 and gateways 14 in IEEE bands such as the IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), and/or any other desired satellite communications (satcom) bands. If desired, different bands may be used for the satellite-to-user equipment links than for the satellite-to-gateway links.

Communications may be performed between gateways 14 and UE devices 10 in a forward link (FWD) direction and/or in a reverse link (REV or RWD) direction. In the FWD direction (sometimes referred to simply as the forward link), wireless data is conveyed from gateway(s) 14 to UE device(s) 10 via constellation 32. Wireless data conveyed over the forward link is sometimes referred to herein as forward link data or FWD data. The FWD data may include one or more FWD messages organized into a set, series, or stream of one or more FWD datagrams (e.g., where each FWD datagram has one or more header fields that contain header information with a destination address identifying a corresponding UE device, a payload field that contains a forward link data payload, etc.). Gateways 14 may receive FWD messages for transmission to UE devices 10 from network portion 18.

A gateway 14 may, for example, transmit radio-frequency signals 28 to constellation 32. Gateway 14 may transmit FWD data (e.g., in one or more FWD messages) by modulating one or more FWD datagrams onto one or more carriers of radio-frequency signals 28. Satellite 12 may transmit (e.g., forward or relay, in a bent-pipe configuration) the incident FWD data to UE device(s) 10 using radio-frequency signals 26 (e.g., without decoding or demodulating the FWD data between receiving the FWD data in radio-frequency signals 28 and transmitting the FWD data in radio-frequency signals 26). Radio-frequency signals 28 are conveyed in an uplink direction from gateway 14 to satellite 12 and are therefore sometimes also referred to herein as uplink (UL) signals 28, forward link UL signals 28, forward link signals 28, or FWD signals 28. Radio-frequency signals 26 are conveyed in a downlink direction from satellite 12 to UE device(s) 10 and are therefore sometimes also referred to herein as downlink (DL) signals 26, forward link DL signals 26, forward link signals 26, or FWD signals 26. Forward link signals conveyed from gateways 14 to UE devices 10 via constellation 32 may include forward link data, control signals, broadcast messages, and/or other types of FWD signals and/or waveforms.

In the reverse link direction (sometimes referred to simply as the reverse link), wireless data is conveyed from UE device(s) 10 to gateway(s) 14 via constellation 32. Wireless data conveyed over the reverse link is sometimes referred to herein as reverse link data, RWD data, or REV data. The RWD data may include one or more RWD messages organized into a set, series, or stream of one or more RWD datagrams (e.g., where each RWD datagram has one or more header fields that contain header information with a destination address identifying a corresponding destination terminal, a payload field that contains a reverse link data payload, etc.).

A UE device 10 may, for example, transmit radio-frequency signals 24 to one of the satellites 12 in constellation 32. UE device 10 may transmit RWD data (e.g., one or more RWD messages) by modulating one or more RWD datagrams onto one or more carriers of radio-frequency signals 24. Satellite 12 may transmit (e.g., forward or relay, in a bent-pipe configuration) the incident RWD data to gateway(s) 14 using radio-frequency signals 30 (e.g., without decoding or demodulating the RWD data between receiving the RWD data in radio-frequency signals 24 and transmitting the RWD data in radio-frequency signals 30). Radio-frequency signals 24 are conveyed in an uplink direction from UE device 10 to satellite 12 and are therefore sometimes also referred to herein as uplink (UL) signals 24, reverse link UL signals 24, reverse link signals 24, or RWD signals 24. Radio-frequency signals 30 are conveyed in a downlink direction from satellite 12 to gateway(s) 14 and are therefore sometimes also referred to herein as downlink (DL) signals 30, reverse link DL signals 30, reverse link signals 30, or RWD signals 30. Reverse link signals conveyed from UE devices 10 to gateways 14 via constellation 32 may include reverse link data and/or other types of RWD signals and/or waveforms. Gateway 14 may forward incident RWD data to terrestrial network 34. Terrestrial network 34 may forward the RWD data to any desired network nodes or terminals of terrestrial network 34.

If desired, a UE device 10 may include separate antennas for handling communications over the satellite-to-user equipment link and one or more terrestrial network wireless communication links 2. Alternatively, UE device 10 may include a single antenna that handles both the satellite-to-user equipment link and the terrestrial network wireless communications links. Baseband and/or radio-frequency circuitry on UE devices 10 generate RWD data for transmission to gateways 14. On the other hand, FWD data may be generated by any desired network nodes or terminals of terrestrial network 34. The FWD data and the RWD data may include text data such as email messages, text messages (e.g., SMS messages or messages sent using other text-based messaging protocols), web browser data, an emergency or SOS message, a location message identifying the location of UE device(s) 10, a location message identifying the location of other devices, and/or other text-based data, audio data such as voice data (e.g., for a bi-directional satellite voice call) or other audio data (e.g., streaming satellite radio data), video data (e.g., for a bi-directional satellite video call or to stream video data transmitted by gateway 14 at UE device(s) 10), cloud network synchronization data, data generated or used by software applications running on UE device(s) 10 (e.g., application data), data for use in a distributed processing network (e.g., a cloud computing network), and/or any other desired data. UE devices 10 may only receive FWD data, may only transmit RWD data, or may both transmit RWD data and receive FWD data. Each satellite 12 exhibits a corresponding wireless coverage area. Each satellite 12 may communicate with the UE devices 10 located within its coverage area at any given time (e.g., UE devices 10 located within cells on Earth that overlap the signal beam(s) producible by the satellite).

The satcom network service provider for communications system 38 may operate, control, and/or manage a satcom control network such as core network (CN) 20 in terrestrial network 34. CN 20 is sometimes also referred to herein as satcom network region 20, CN region 20, satcom controller 20, satcom network 20, or satcom service provider equipment 20. CN 20 may be implemented on one or more network nodes and/or terminals of terrestrial network 34 (e.g., one or more servers or other end hosts). In some implementations, CN 20 may be formed from a cloud computing network distributed over multiple underlying physical network nodes and/or terminals distributed across one or more geographic regions. CN 20 may therefore sometimes also be referred to as a CN cloud region or satcom network cloud region.

CN 20 may control and coordinate wireless communications between terminals (e.g., end hosts) of terrestrial network 34 and UE devices 10 via constellation 32. For example, gateways 14 may receive RWD data (e.g., one or more RWD messages) from UE devices 10 via constellation 32 and may route the RWD data to CN 20. CN 20 may perform any desired processing operations on the RWD data. For example, CN 20 may identify destinations (recipients or receivers) for the RWD data (e.g., from destination or receiver addresses in header fields of the RWD datagrams carrying/representing the RWD data) and may forward the RWD data to the identified destinations. CN 20 may also receive FWD data for transmission to UE devices 10 from one or more terminals or end hosts of terrestrial network 34 (e.g., network portion 18). CN 20 may process the FWD data to schedule the FWD data for transmission to UE devices 10 via constellation 32. CN 20 may schedule the FWD data for transmission to UE devices 10 by generating forward link traffic grants for each of the UE devices that are to receive FWD data. CN 20 may provide the FWD data (e.g., one or more FWD messages) and the forward link traffic grants to gateways 14. Gateways 14 may transmit the FWD data to UE devices 10 via constellation 32 according to the forward link traffic grants (e.g., according to a forward link communications schedule that implements the forward link traffic grants).

The time resources used for satellite-based communications between CN 20 and a UE device 10 may be divided into a series of repeating system cycles over time (sometimes also referred to as system frames or communications cycles). Each system cycle may include a respective FWD cycle (sometimes also referred to as a downlink cycle) and/or a respective RWD cycle (sometimes also referred to as an uplink cycle). During each FWD cycle, CN 20 may transmit a respective broadcast (BC) message (e.g., containing broadcast information) to all the UE devices 10 served by a given satellite 12 via that satellite 12 (e.g., in a broadcast interval (BCI) of the FWD cycle). The satellite 12 that communicates with a given UE device 10 is sometimes also referred to herein as the serving satellite 12 of that UE device 10. CN 20 may also transmit one or more unicast messages (e.g., FWD messages containing FWD data) to one or more of the UE devices 10 served by the serving satellite during the FWD cycle (e.g., during a portion of the FWD cycle not occupied by the broadcast interval). During a RWD cycle, a UE device 10 may transmit a RWD message (e.g., containing RWD data) to CN 20 via its serving satellite 12. The RWD message may include, for example, one, two, or more than two RWD datagrams. The RWD cycle may have the same duration as the FWD cycle or may have a different duration. Each system cycle may have a duration (period) of between 2 seconds and 3 seconds (e.g., 2.56 seconds), between 1 second and 10 seconds, between 1 second and 5 seconds, greater than 1 second, greater than 2 seconds, less than 5 seconds, less than 10 seconds, or other durations. This is illustrative and, in general, the embodiments described herein may apply to any desired underlying satellite network technologies having any desired system cycles and having communications with any desired division of time and/or frequency resources. If desired, the constellation 32 of satellites 12 in any of the embodiments described herein may be replaced with an aerial constellation (e.g., where aerial vehicles or aircraft replace satellites 12) or a terrestrial-based network (e.g., where terrestrial nodes replace satellites 12).

In some implementations that are described herein as an example, UE device 10B may paired or otherwise associated with UE device 10A. UE devices 10A and 10B may, for example, be owned and/or operated by the same end user and/or communications (e.g., messaging) software running on UE devices 10A and 10B (e.g., in the operating system(s) of UE devices 10A and 10B and/or in another set of one or more software applications stored on and executed by UE devices 10A and 10B) may be logged into or associated with the same user account (e.g., a user account or subscription with the operator(s) of CN 20 and/or carrier network 22 for access to communications/messaging capabilities via CN 20 and/or carrier network 22). UE devices 10A and 10B may be, for example, different types of devices. Implementations in which UE device 10A is a cellular telephone or a similar electronic device and UE device 10B is a wristwatch, ring device, bracelet device, anklet device, head-mounted display device, or another relatively small (e.g., wearable) device that are owned and/or operated by the same end user and/or or that are logged into the same messaging service account(s) are sometimes described herein as a non-limiting example.

When UE device 10B is within radio-frequency communications range of UE device 10A (e.g., such that radio-frequency signals transmitted by one UE device are received by the other UE device with at least a threshold signal level), UE device 10B may wirelessly communicate directly with UE device 10A over a direct communications link 4 (e.g., without communications passing through an intervening device such as an AP or BS). Communications link 4 is sometimes also referred to herein as UE-to-UE communications link 4, UE-to-UE link 4, or inter-UE link 4. UE-to-UE link 4 does not pass through BS 21 or any other network nodes or devices.

UE devices 10A and 10B may convey wireless data with each other (e.g., text messages, voice data, other cellular data, etc.) over UE-to-UE link 4 using radio-frequency signals conveyed between UE devices 10A and 10B. UE-to-UE link 4 may be supported using WLAN signals (e.g., Wi-Fi signals, Wi-Fi direct signals, P2P signals, C2C signals, etc.), WPAN signals (e.g., Bluetooth or Ultra Low Latency Audio signals), D2D signals, cellular telephone signals, etc. In other words, UE-to-UE link 4 may be a WLAN link (e.g., a Wi-Fi direct link), a D2D link, a P2P link, a C2C link, a WPAN link (e.g., a Bluetooth link), a cellular telephone link, etc. UE devices 10A and 10B may establish a connection over UE-to-UE link 4 (e.g., using a handshake or message and/or credential exchange/authorization procedure) and may then use the established connection to convey wireless data between the devices. When UE devices 10A and 10B have established UE-to-UE link 4, UE device 10B is sometimes referred to as being connected to or paired with UE device 10A and UE device 10A is sometimes referred to as being connected to or paired with UE device 10B.

In practice, the user of UE devices 10A and 10B may wish to convey communications data with another UE device such as UE device 10C (e.g., a UE device that is owned and/or operated by a different user and/or that is associated with a different account or subscription to carrier network 22 and/or CN 20). For example, when UE device 10A is on-grid, UE device 10A may convey communications data (e.g., text-based messages such as SMS messages or messages of a different protocol) to UE device 10C via terrestrial network 34. This may include, for example, UE device 10A transmitting communications data to BS 21 over terrestrial network wireless communication link 2, BS 21 forwarding the transmitted data to carrier network 22, and carrier network 22 forwarding the transmitted data to UE device 10C via CN 20 or directly (e.g., without forwarding the transmitted data to CN 20). Additionally, or alternatively, UE device 10C may transmit communications data to UE device 10A via terrestrial network 34. This may include, for example, UE device 10C transmitting communications data to carrier network 22 (e.g., directly or via CN 20), carrier network 22 forwarding the transmitted data to BS 21, and BS 21 conveying the transmitted data to UE device 10A via over terrestrial network wireless communication link 2. UE device 10A may use identification information and/or credentials associated with the account/subscription of the user of UE devices 10A and 10B (e.g., as stored on a SIM of UE device 10A) to access carrier network 22 for conveying data between UE devices 10A and 10C. The identification information may include, for example, a Mobile Station International Subscriber Directory Number (MSISDN) (e.g., a globally unique telephone number), an account name, and/or a user handle (e.g., email address, profile name, screen name, etc.) associated with the user and/or the account.

In some situations, the user of UE devices 10A and 10B may generate communications data for transmission to UE device 10C at UE device 10B (e.g., using a software application running on UE device 10B, using a user input device of or coupled to UE device 10B, etc.). The data may include, for example, one or more text-based messages (e.g., SMS messages or messages of a different protocol). In some implementations, UE device 10B may have its own credentials (e.g., its own SIM) that UE device 10B uses to access terrestrial network 34 (e.g., carrier network 22). In these situations, when UE device 10B is on-grid, UE device 10B may convey wireless data with UE device 10C over a terrestrial network wireless communications link between UE device 10B and BS 21, carrier network 22, and optionally CN 20 using its own credentials.

In other implementations, UE device 10B may utilize the credentials (e.g., SIM) of UE device 10A to access carrier network 22 and/or terrestrial network 34. In these situations, when UE device 10B is on-grid and/or connected to UE device 10A over UE-to-UE link 4, UE device 10A may serve as a relay device for communications between UE device 10B and UE device 10C. For example, UE device 10B may transmit communications data (e.g., one or more text-based messages such as SMS messages or text-based messages of a different protocol) to UE device 10A over UE-to-UE link 4. UE device 10A may then forward (transmit) the communications data received from UE device 10B to BS 21 over terrestrial network wireless communication link 2 (e.g., using the credentials and/or SIM of UE device 10A). BS 21 may forward the communications data to carrier network 22. Carrier network 22 may forward the communications data to UE device 10C directly or via CN 20. Conversely, UE device 10C may transmit communications data to carrier network 22 directly or via CN 20. Carrier network 22 may forward the communications data to BS 21. BS 21 may transmit the communications data to UE device 10A over terrestrial network wireless communication link 2 (e.g., where UE device 10A has connected to BS 21 and carrier network 22 using its own credentials and/or SIM). In this way, UE device 10B may utilize UE device 10A to relay messages between UE device 10A and UE device 10C without requiring the user of UE devices 10A and 10B to obtain, pay for, and/or maintain a separate account, subscription, and/or SIM for UE device 10B in addition to the account, subscription, and/or SIM of UE device 10A. From the perspective of BS 21, carrier network 22, and/or UE device 10C, UE device 10C communicates with UE device 10A instead of UE device 10B (e.g., UE device 10A serves as a proxy for UE device 10B from the perspective of BS 21, carrier network 22, and/or UE device 10C).

In practice, situations may arise where UE device 10B moves out of range of UE device 10A and/or off-grid. For example, as shown by arrow 31, UE device 10B may move from location 6 at time T1 to a location outside of the coverage areas 8 of the base stations of carrier network 22 (e.g., BS 21) and/or out of range of UE device 10A (at time T2). This may occur, for example, when the user of UE devices 10A and 10B leaves UE device 10A at home, in their car, or otherwise in place at a first location while taking UE device 10B with them to another location away from the first location and potentially off-grid (e.g., while swimming, surfing, hiking, walking, boating, driving, playing sports, or performing other activities using UE device 10B but not UE device 10A). Situations such as these may, for example, be particularly frequent when UE device 10B is smaller and/or more portable than UE device 10A (e.g., when UE device 10B is a wristwatch or other wearable device whereas UE device 10A is a cellular telephone, laptop computer, tablet computer, desktop computer, or other less portable and/or waterproof device than UE device 10B).

In these situations, it may be desirable for UE device 10B to continue to convey communications data with UE device 10C using UE device 10A as a proxy for UE device 10B (e.g., allowing the user to maintain seamless contact with UE device 10C without needing to obtain, pay for, and/or maintain a separate account, SIM, and/or subscription for UE device 10B for accessing terrestrial network 34). UE device 10B may, for example, communicate with UE device 10C via constellation 32 while UE device 10A serves as a proxy or relay device for UE device 10A (e.g., using the credentials, account, SIM, and/or subscription of UE device 10A to access terrestrial network 34).

FIG. 1 shows one example of how communication data may be conveyed between UE device 10C and UE device 10B via constellation 32 and relay by UE device 10A (e.g., after UE device 10B has gone off-grid and registered with and/or connected to CN 20 via constellation 32 for performing satellite-based communications). As shown by arrow A1, UE device 10B may first transmit Mobile Originated (MO) communication data (e.g., one or more text-based messages in one or more reverse link transmissions) to its paired relay device (e.g., UE device 10A). This may include, for example, transmitting the communication data to one or more satellites 12 in constellation 32 (e.g., using UL signals 24). Satellite(s) 12 may forward (e.g., route, transmit, relay, direct, etc.) the communication data to one or more gateways 14 (e.g., using DL signals 30). Gateway(s) 14 may forward (e.g., route, transmit, relay, direct, etc.) the communication data to CN 20.

CN 20 may process the communication data (e.g., one or more header fields to verify service of UE device 10B and/or UE device 10A, to identify a carrier network 22 associated with UE device 10A, UE device 10B, and/or the communication data, to identify a destination of the communication data, etc.) and may forward (e.g., route, transmit, relay, direct, etc.) the communication data to carrier network 22. Carrier network 22 may forward (e.g., route, transmit, relay, direct, etc.) the communication data to BS 21. Alternatively, CN 20 may forward the communication data directly to BS 21 (or another type of wireless communication equipment such as an AP) without passing the communication data to carrier network 22 (e.g., in implementations where the communication data does not include communication data that is conveyed over a cellular network, when the credentials of UE device 10A and/or 10B are associated only with CN 20, etc.). BS 21 may transmit the communication data to UE device 10A over terrestrial network wireless communication link 2.

UE device 10A may receive the communication data transmitted by UE device 10B from BS 21. UE device 10A may process and store the communication data. If desired, UE device 10A may display information about or included in the communication data on a display. If desired, UE device 10A may convert the communication data into a different format. For example, UE device 10A may include, indicate, or identify its own credentials and/or information about UE device 10A in the communication data (e.g., in one or more header fields of the communication data) that replaces credentials and/or information about UE device 10B in the communication data. This may configure the converted communication data to appear, to least BS 21, carrier network 22, CN 20, and/or UE device 10C, as having been transmitted by UE device 10A instead of the off-grid UE device 10B (e.g., configuring UE device 10A to serve as a proxy for UE device 10B).

As shown by arrow A2, UE device 10A may then transmit (e.g., relay) the (converted) communication data to BS 21 via terrestrial network wireless communication link 2. BS 21 may forward the communication data to carrier network 22. Carrier network 22 may forward the communication data to CN 20. CN 20 may forward the communication data to UE device 10C. Alternatively, BS 21 (or another type of wireless communication equipment such as an AP) may forward the communication data directly to CN 20 without passing the communication data to carrier network 20 (e.g., in implementations where the communication data does not include communication data that is conveyed over a cellular network, when the credentials of UE device 10A and/or 10B are associated only with CN 20, etc.).

UE device 10C may also transmit Mobile Terminated (MT) communication data to UE device 10A via relay by UE device 10A and constellation 32. As shown by arrow A3, UE device 10C may first transmit MT communication data (e.g., one or more text-based messages) to UE device 10A. This may include transmitting the communication data to CN 20 (e.g., via carrier network 22 or via other portions or links in terrestrial network 34). CN 20 may process the communication data (e.g., one or more header fields to verify service of UE device 10B and/or UE device 10A, to identify a carrier network 22 associated with UE device 10A, UE device 10B, and/or the communication data, to identify a destination of the communication data, etc.) and may forward the communication data to carrier network 22. Carrier network 22 may forward the communication data to BS 21. Alternatively, CN 20 may forward the communication data directly to BS 21 (or another type of wireless communication equipment such as an AP) without passing the communication data to carrier network 22 (e.g., in implementations where the communication data does not include communication data that is conveyed over a cellular network, when the credentials of UE device 10A and/or 10B are associated only with CN 20, etc.). BS 21 may transmit the communication data to UE device 10A over terrestrial network wireless communication link 2. If desired, UE device 10C and carrier network 22 may have no knowledge that UE device 10A will relay its MT communication data to UE device 10B (e.g., because communication data conveyed between UE device 10A and UE device 10C may be devoid of information identifying UE device 10B).

UE device 10A may receive the communication data transmitted by UE device 10C from BS 21. UE device 10A may process and store the communication data. If desired, UE device 10A may display information about or included in the communication data on a display. If desired, UE device 10A may convert the communication data into a different format. As shown by arrow A4, UE device 10A may then transmit (e.g., relay) the (converted) communication data to UE device 10B via constellation 32. This may include, for example, transmitting the communication data to BS 21. BS 21 may forward the communication data to carrier network 22. Carrier network 22 may forward the communication data to CN 20. CN 20 may forward the communication data to gateway 14 (e.g., in a corresponding forward link grant). Alternatively, BS 21 (or another type of wireless communication equipment such as an AP) may forward the communication data directly to CN 20 without passing the communication data to carrier network 22 (e.g., in implementations where the communication data does not include communication data that is conveyed over a cellular network, when the credentials of UE device 10A and/or 10B are associated only with CN 20, etc.).

Gateway 14 may transmit the communication data to one or more satellites 12 (e.g., in one or more forward link transmissions) in constellation 32 (e.g., in UL signals 28, in accordance with the corresponding forward link grant). Satellite(s) 12 may forward the communication data to UE device 10B (e.g., in DL signals 26). UE device 10B may process and store the received communication data. If desired, UE device 10B may display information included within and/or associated with the received communication data on a display or other user output device. In this way, the user of UE devices 10A and 10B may continue to communicate with UE device 10C using UE device 10B even after UE device 10B moves off-grid, with UE device 10A serving as a relay and proxy between satellite-based communications over constellation 32 and terrestrial-based communications over terrestrial network 34, without needing to obtain, purchase, or maintain a separate account, subscription, and/or account for accessing the communication services of CN 20 and/or carrier network 22.

The example of FIG. 1 is illustrative and non-limiting. If desired, an inter-working function (IWF) server (not shown) may be communicatively coupled between CN 20 and carrier network 22 in terrestrial network 34. The IWF server may be logically or virtually defined over any desired number of underlying physical devices. The IWF server is sometimes also referred to as an IWF or carrier interface. If desired, the IWF may be managed, controlled, operated, and/or owned by a neutral third party entity or arbitrator that is different from (e.g., that is unaffiliated with) both the satcom network service provider of CN 20 and the MNO of carrier network 22. The IWF may serve as a communications interface between CN 20 and carrier network 22 during the routing of wireless data for UE devices 10A and/or 10B if desired. CN 20 and the IWF may help to filter messaging to UE device 10B while off-grid (e.g., to help preserve bandwidth via constellation 32). The IWF may also help to obfuscate identifying information about UE devices 10 and/or CN 20 from carrier network 22. The IWF may be omitted from terrestrial network 34 if desired.

A UE device 10 may be a computing device such as a laptop computer, a desktop computer, a computer monitor (e.g., containing an embedded computer), a tablet computer, a cellular telephone, a media player, or another handheld or portable electronic device, a smaller device such as a wristwatch device, a pendant device, a headphone or earpiece device, a device embedded in eyeglasses or other equipment worn on a user's head (e.g., a virtual, mixed, and/or augmented reality headset, glasses, goggles, or helmet), a ring device worn on a user's finger, or another type of wearable or miniature device, a television, a computer display (e.g., that does not contain an embedded computer), a gaming device (e.g., a portable gaming system, a non-portable gaming system, etc.), a navigation device, an embedded system such as a system in which electronic equipment with a display is mounted in a kiosk, furniture, building, wall, an automobile, or another type of vehicle, a wireless internet-connected voice-controlled speaker, a home entertainment device, a remote control device, a gaming controller, a peripheral user input device, a wireless access point, equipment that implements the functionality of two or more of these devices, or other electronic equipment.

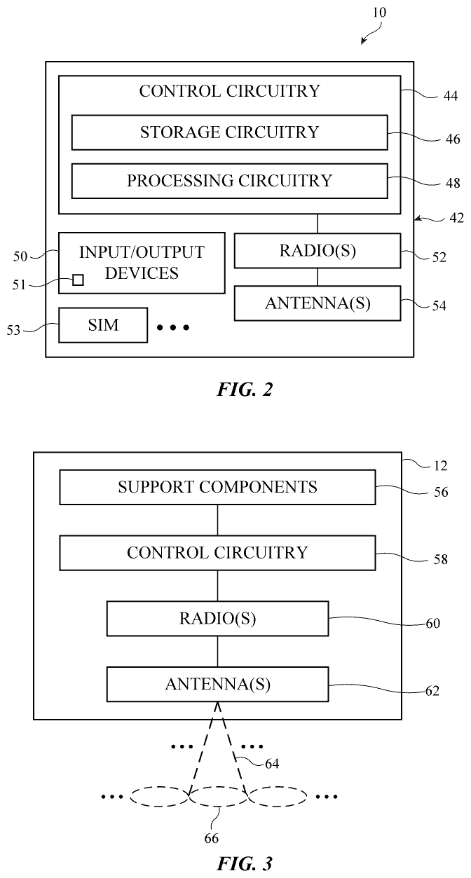

As shown in FIG. 2, UE device 10 may include components located on or within an electronic device housing such as housing 42. Housing 42, which is sometimes also referred to as a case, may be formed of plastic, glass, ceramics, fiber composites, metal (e.g., stainless steel, aluminum, metal alloys, etc.), other suitable materials, or a combination of these materials. In some situations, parts or all of housing 42 may be formed from dielectric or other low-conductivity material (e.g., glass, ceramic, plastic, sapphire, etc.). In other situations, housing 42 or at least some of the structures that make up housing 42 may be formed from metal elements.

UE device 10 may include control circuitry 44. Control circuitry 44 may include storage such as storage circuitry 46. Storage circuitry 46 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 46 may include storage that is integrated within UE device 10 and/or removable storage media.

Control circuitry 44 may include processing circuitry such as processing circuitry 48. Processing circuitry 48 may be used to control the operation of UE device 10. Processing circuitry 48 may include on one or more processors (e.g., microprocessors, microcontrollers, digital signal processors, host processors, applications processors, baseband processor integrated circuits, application specific integrated circuits, central processing units (CPUs), graphics processing units (GPUs), etc.). Control circuitry 44 may be configured to perform operations in device 10 using hardware (e.g., dedicated hardware or circuitry), firmware, and/or software. Software code for performing operations on UE device 10 may be stored on storage circuitry 46 (e.g., storage circuitry 46 may include non-transitory (tangible) computer readable storage media that stores the software code). The software code is sometimes also referred to as program instructions, software, data, instructions, or code. Software code stored on storage circuitry 46 may be executed by processing circuitry 48.

Control circuitry 44 may be used to run software on UE device 10 such as satellite navigation applications, internet browsing applications, voice-over-internet-protocol (VOIP) telephone call applications, email applications, cloud computing applications, media playback applications, operating system functions, etc. To support interactions with external equipment, control circuitry 44 may be used in implementing communications protocols. Communications protocols that may be implemented using control circuitry 44 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), satellite communications protocols, and/or any other desired communications protocols. Each communications protocol may be associated with a corresponding radio access technology (RAT) that specifies the physical connection methodology used in implementing the protocol.

UE device 10 may store satellite information associated with one or more of the satellites 12 in constellation 32 on storage circuitry 46. The satellite information, sometimes referred to herein as ephemeris data, ephemeris information, or satellite ephemeris, may include a satellite almanac identifying the orbital parameters/position (e.g., orbit information, elevation information, altitude information, inclination information, eccentricity information, orbital period information, trajectory information, right ascension information, declination information, ground track information, etc.) and/or the velocity of satellites 12 (e.g., relative to the surface of Earth). This information may include a two-line element (TLE), for example. The TLE may identify or include information about the orbital motion of one or more of the satellites 12 in constellation 32 (e.g., satellite epoch, first and/or second derivatives of motion, drag terms, etc.). The TLE may be in the format of a text file having two lines or columns that include the set of elements forming the TLE, for example. Control circuitry 44 may use the ephemeris data to calculate, predict, or identify the location of satellites 12 at different points in time.

UE device 10 may also include wireless communications circuitry to support wireless communications. The wireless communications circuitry may include one or more antennas 54 and one or more radios 52. Each radio 52 may include circuitry that operates on signals at baseband frequencies (e.g., baseband processing circuitry, one or more baseband processors, etc.), signal generator circuitry, modulation/demodulation circuitry (e.g., one or more modems), radio-frequency transceiver circuitry (e.g., radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, etc.), amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, and/or any other circuitry for transmitting and/or receiving radio-frequency signals using antenna(s) 54. The components of each radio 52 may be mounted onto a respective substrate or integrated into a respective integrated circuit, chip, package, or system-on-chip (SOC). If desired, the components of multiple radios 52 may share a single substrate, integrated circuit, chip, package, or SOC.

Antenna(s) 54 may be formed using any desired antenna structures. For example, antenna(s) 54 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas 54 may include antenna resonating elements formed from conductive portions of housing 42 (e.g., peripheral conductive housing structures extending around a periphery of a display on UE device 10). Filter circuitry, switching circuitry, impedance matching circuitry, and/or other antenna tuning components may be adjusted to adjust the frequency response and wireless performance of antenna(s) 54 over time. If desired, multiple antennas 54 may be implemented as a phased array antenna (e.g., where each antenna forms a radiator or antenna element of the phased array antenna, which is sometimes also referred to as a phased antenna array). In these implementations, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time. When receiving signals, the pointing direction of the signal beam corresponds to phase and magnitude settings that cause radio-frequency signals incident upon each of the antenna elements to coherently add together in the receive path of radio(s) 52.

Transceiver circuitry in radios 52 may convey radio-frequency signals using one or more antennas 54 (e.g., antenna(s) 54 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antenna(s) 54 may transmit the radio-frequency signals by radiating the radio-frequency signals into free space (or to free space through intervening device structures such as a dielectric cover layer). Antenna(s) 54 may additionally or alternatively receive the radio-frequency signals from free space (e.g., through intervening devices structures such as a dielectric cover layer). The transmission and reception of radio-frequency signals by antenna(s) 54 each involve the excitation or resonance of antenna currents on an antenna resonating element in the antenna by the radio-frequency signals within the frequency band(s) of operation of the antenna.

Each radio 52 may be communicatively coupled to one or more antennas 54 over one or more radio-frequency transmission lines. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency transmission lines may be shared between radios 52 if desired. Radio-frequency front end (RFFE) modules may be interposed on one or more of the radio-frequency transmission lines. The radio-frequency front end modules may include substrates, integrated circuits, chips, or packages that are separate from radios 52 and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Radios 52 may use antenna(s) 54 to transmit and/or receive radio-frequency signals within different frequency bands at radio frequencies (sometimes referred to herein as communications bands or simply as a “bands”). The frequency bands handled by radios 52 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR 1) bands below 10 GHz, 5G New Radio Frequency Range 2 (FR 2) bands between 20 and 60 GHz, 6G bands such as sub-THz bands between around 100 GHz and around 10 THz, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Although control circuitry 44 is shown separately from radios 52 in the example of FIG. 2 for the sake of clarity, radios 52 may include processing circuitry that forms a part of processing circuitry 48 and/or storage circuitry that forms a part of storage circuitry 46 of control circuitry 44 (e.g., portions of control circuitry 44 may be implemented on radios 52). As an example, control circuitry 44 may include baseband circuitry or other control components that form a part of radios 52. The baseband circuitry may, for example, access a communication protocol stack on control circuitry 44 (e.g., storage circuitry 46) to: perform functions at a physical (PHY) layer (e.g., Layer 1 of the Open Systems Interconnection (OSI) model), a data link layer (e.g., a medium access control (MAC) layer, a logical link control (LLC) layer, etc.), a radio link control (RLC) layer, a packet data convergence protocol (PDCP) layer, a service data adaptation protocol (SDAP) layer, a protocol data unit (PDU) layer, etc., and/or to perform control plane functions at the PHY layer, MAC layer, RLC layer, PDCP layer, radio resource control (RRC) layer, non-access stratum (NAS) layer, etc. Processing circuitry 48 may include an applications processor (AP) that executes one or more software applications and/or an operating system that accesses and operates on data at the application (APP) layer.

UE device 10 may include input-output devices 50. Input-output devices 50 may be used to allow data to be supplied to UE device 10 and to allow data to be provided from UE device 10 to external devices. Input-output devices 50 may include user interface devices, data port devices, and other input-output components. For example, input-output devices 50 may include touch sensors, displays such as display 51 (e.g., a touch-sensitive and/or force-sensitive display), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, orientation sensors, inertial measurement units, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 50 may be peripherals that are coupled to a main processing unit or other portion of device 10 via a wired or wireless link).

UE device 10 may include one or more SIMs such as SIM 53. SIM 53 may be associated with (e.g., owned or managed by) a corresponding carrier network 22 (FIG. 1). Radio 52 may use SIM 53 to access the associated carrier network 22 (e.g., to use carrier network 22 to route wireless data for the UE device). SIM 53 may include a SIM card, may be integrated into UE device 10 (e.g., may be an eSIM), or may be a removable SIM card. If desired, UE device 10 may include multiple SIMs for supporting multi-SIM communications with multiple different carrier networks 22. SIM 53 may identify a corresponding subscription to the wireless services of the corresponding carrier network 22 and may include, identify, or otherwise be associated with a corresponding SIM credential. The user who holds the subscription (e.g., the user of UE device 10) is sometimes referred to as a subscriber of the corresponding carrier network 22.

Each subscription to a carrier network 22 may have a corresponding Mobile Station International Subscriber Directory Number (MSISDN) (e.g., representing a globally unique telephone number associated with the subscription). SIM 53 may therefore include or store information identifying or indicating its corresponding MSISDN (e.g., the MSISDN of UE device 10). The corresponding carrier network 22 may include a subscription manager that stores and/or identifies all subscribers, subscriptions, and MSISDNs of the carrier network. The carrier network may use its subscription manager to verify the MSISDN of UE device 10 (e.g., using a challenge and response scheme) before providing UE device 10 with cellular telephone service (e.g., text message routing service). The MSISDN of SIM 53 may be unique to UE device 10 or may be shared by the same subscriber between multiple UE devices if desired. In the example of FIG. 1, if desired, UE device 10B may utilize the SIM 53 of UE device 10A when communicating with UE device 10C via constellation 32 and relay by UE device 10A (e.g., to access carrier network 22 even if/when UE device 10B does not have its own SIM).

A gateway 14 (FIG. 1) may include one or more radios that include one or more components similar to radio(s) 52, one or more antennas, one or more input/output devices, and control circuitry that includes one or more components similar to control circuitry 44. Unlike UE devices 10, which are generally mobile and able to move between different locations, gateway 14 is stationary and remains at a fixed location on Earth. Gateways 14 are not owned or operated by end users of UE devices 10. Gateway 14 may include one or more electronic devices such as one or more servers or terminals. The electronic device(s) of a gateway 14 may be enclosed within a housing, enclosure, building, etc.

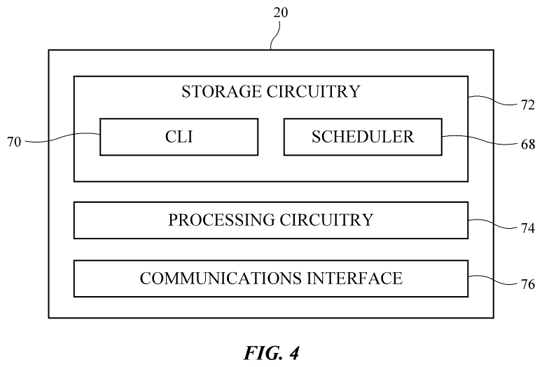

FIG. 3 is a diagram of an illustrative satellite 12 in constellation 32. As shown in FIG. 3, satellite 12 may include satellite support components 56. Support components 56 may include batteries, solar panels, sensors (e.g., accelerometers, gyroscopes, temperature sensors, light sensors, etc.), guidance systems, propulsion systems, and/or any other desired components associated with supporting satellite 12 in orbit above Earth.

Satellite 12 may include control circuitry 58. Control circuitry 58 may be used in controlling the operations of satellite 12. Control circuitry 58 may include processing circuitry such as processing circuitry 48 of FIG. 2 and may include storage circuitry such as storage circuitry 46 of FIG. 2. Control circuitry 58 may also control support components 56 to adjust the trajectory or position of satellite 12 in space.

Satellite 12 may include antennas 62 and one or more radios 60. Radios 60 may use antennas 62 to transmit DL signals 26 and DL signals 30 and to receive UL signals 24 and UL signals 28 of FIG. 1 (e.g., in one or more satellite communications bands). Radios 60 may include transceivers, modems, integrated circuit chips, application specific integrated circuits, filters, switches, up-converter circuitry, down-converter circuitry, analog-to-digital converter circuitry, digital-to-analog converter circuitry, amplifier circuitry (e.g., multiport amplifiers), beam steering circuitry, etc.

Antennas 62 may include any desired antenna structures (e.g., patch antenna structures, dipole antenna structures, monopole antenna structures, waveguide antenna structures, Yagi antenna structures, inverted-F antenna structures, cavity-backed antenna structures, combinations of these, etc.). In some implementations, antennas 62 may include one or more phased array antennas. Each phased array antenna may include beam forming circuitry having a phase and magnitude controller coupled to each antenna element in the phased array antenna. The phase and magnitude controllers may provide a desired phase and magnitude to the radio-frequency signals conveyed over the corresponding antenna element. The phases and magnitudes of each antenna element may be adjusted so that the radio-frequency signals conveyed by each of the antenna elements constructively and destructively interfere to produce a radio-frequency signal beam 64 in a desired pointing direction (e.g., an angular direction towards Earth at which the radio-frequency signal beam exhibits peak gain). Radio-frequency lenses may also be used to help guide the radio-frequency signal beam in a desired pointing direction. Each radio-frequency signal beam also exhibits a corresponding beam width. This allows each radio-frequency signal beam to cover a corresponding area on Earth (e.g., a region on Earth overlapping the radio-frequency signal beam such that the radio-frequency signal beam exhibits a power greater than a minimum threshold value within that region/cell). Satellite 12 may convey radio-frequency signals over multiple concurrently-active signal beams 64 if desired. If desired, satellite 12 may offload some or all of its beam forming operations to gateway 14 and/or CN 20. Signal beams 64 may sometimes be referred to herein simply as beams 64.

A phased array antenna in satellite 12 may have a set of formable signal beams 64 each oriented in a different beam pointing direction or angle (e.g., a direction or angle of peak signal gain). Each signal beam 64 may be formed using a different respective set of phase and magnitude settings for the antenna elements in the phased array antenna and/or using a different respective set of active antenna elements in the phased array antenna. Satellite 12 may transmit and/or receive radio-frequency signals within the active signal beam(s) 64 of the phased array antenna (e.g., satellite 12 may wirelessly serve UE devices 10 that overlap active signal beam(s) 64). Inactive signal beam(s) 64 do not convey radio-frequency signals. Active signal beams 64 are sometimes also referred to as illuminated, enabled, powered, or energized signal beams 64. Inactive signal beams 64 are sometimes also referred to as unilluminated, disabled, unpowered, or de-energized signal beams 64.

If desired, satellite 12 may switch between different active signal beams 64 over time according to a beam hopping scheme or schedule. The beam hopping scheme may identify a time schedule for the activation of different signal beams 64 for each system cycle of satellite 12 (e.g., such that each signal beam is active at least once during each system cycle). If desired, gateway(s) 14 and/or CN 20 (FIG. 1) may set/specify and/or update the beam hopping schedule for satellite 12. If desired, different satellites may have different beam hopping schedules. If desired, multiple signal beams 64 may be active at the same time in the beam hopping scheme (e.g., where the transmit power of satellite 12 is divided between the active signal beams 64).

Each signal beam 64 of the phased array antenna may overlap a different respective area 66 on Earth. Areas 66 are sometimes also referred to herein as spot beams 66 or cells 66 of satellite 12 or the phased array antenna of satellite 12. Each spot beam 66 represents the projection, onto Earth's surface, of a different respective signal beam 64 of the phased array antenna. The geographic locations on Earth that are overlapped by spot beams 66 change over time as satellite 12 moves in its orbit around Earth. If desired, each spot beam 66 formable by satellite 12 may at least partially overlap at least one other spot beam 66 formable by that satellite 12 to minimize coverage gaps. All of the active and inactive spot beams 66 of the phased array antenna may represent the overall coverage area of the phased array antenna and satellite 12 at a given time.

If desired, radios 60 and antenna(s) 62 may support communications using multiple polarizations. For example, radios 60 and antenna(s) 62 may transmit and receive radio-frequency signals with a first polarization (e.g., a left-hand circular polarization (LHCP)) and may transmit and receive radio-frequency signals with a second polarization (e.g., a right-hand circular polarization (RHCP)). If desired, the set of signal beams 64 formable by satellite 12 may include a first subset of signal beams that convey LHCP signals (e.g., LHCP signal beams) and a second subset of signal beams that convey RHCP signals (e.g., RHCP signal beams). The LHCP and RHCP signal beams may, for example, be produced using respective multiport power amplifiers (MPAs) on satellite 12. This is illustrative and, in general, satellite 12 may produce any desired number of signal beams 64 having any desired polarizations. A satellite 12 may, for example, transmit (forward) one or more broadcast messages and/or one or more FWD datagrams and/or may receive one or more RWD datagrams using some or all of its signal beams during each system cycle of communications between UE devices 10 and CN 20. Different signal beams may, for example, be active during different respective subsets of each system cycle. In other implementations, multiple signal beams may be active during the same portion(s) of each system cycle.

FIG. 4 is a schematic diagram of CN 20. The components of CN 20 may be implemented on one or more underlying physical devices in terrestrial network 34 (FIG. 1). As shown in FIG. 4, CN 20 may include storage circuitry 72 (e.g., similar to storage circuitry 46 of FIG. 2) and processing circuitry 74 (e.g., similar to processing circuitry 48 of FIG. 2). CN 20 may also include one or more communications interfaces such as communications interface 76.

Storage circuitry 72 may store a communications scheduler such as scheduler 68 (e.g., a software-based scheduler that is executed using processing circuitry 74). Scheduler 68 may store communications schedules (e.g., FWD communications schedules) for each of the UE devices 10 that communicate with CN 20 (e.g., that communicate with CN 20 via constellation 32 of FIG. 1 while the UE devices are off-grid and/or that communicate with CN 20 via terrestrial-based communications equipment 22 while the UE devices are on-grid). Scheduler 68 may, for example, generate forward link traffic grants for the UE devices based on and/or implementing the stored communications schedules. Communications interface 76 may transmit FWD data (e.g., as received from another UE device, a CDN, or another data source, terminal, or end host in communications system 38) to UE devices 10 via constellation 32 and gateway(s) 14 (FIG. 1). Communications interface 76 may also receive RWD data from UE devices 10 via constellation 32. Communications interface 76 may forward the RWD data to a corresponding destination (e.g., another UE device, data destination, terminal, or end host in communications system 38). Communications interface 76 may include a wired communications interface (e.g., a cabled interface, an optical interface, etc.) and/or a wireless communications interface (e.g., wireless communications circuitry having one or more antennas).

Storage circuitry 72 may also store congestion level information (CLI) 70. Congestion level information 70 may identify a current congestion level (CL) for each satellite 12 in constellation 32. The congestion level of a given satellite 12 is a quantity that characterizes the amount of data traffic currently being handled by that satellite and/or the amount of data traffic congestion currently being experienced by that satellite (e.g., given that satellite's bandwidth, power, beamforming capabilities, and/or other available communications resources). Congestion level may be characterized and stored on a per-satellite basis (e.g., where CLI 70 includes a current congestion level CL for each satellite 12) and/or may be characterized and stored on a per-beam basis (e.g., where CLI 70 includes a current congestion level for each signal beam of each satellite 12).

A satellite 12 (or a signal beam of the satellite) that is currently serving a relatively high number of UE devices generally exhibits a relatively high congestion level CL. On the other hand, a satellite 12 (or a signal beam of the satellite) that is currently serving no UE devices or a relatively low number of UE devices generally exhibits a relatively low congestion level CL. The magnitude of the congestion level may be identified, defined, or characterized by a corresponding congestion level indicator. The congestion level indicator may be, for example, a numeric value represented by a series of one or more bits. CN 20 may generate, refresh, and/or update CLI 70 during each system cycle of each satellite 12 (e.g., based on the amount of RWD data and/or FWD data and/or the number of UE devices served by each beam of the satellite during each system cycle). CN 20 may store a most recent congestion level for each satellite 12 (or for each beam of each satellite 12) in CLI 70 and may, if desired, store or retain earlier congestion levels for each satellite 12 (or for each beam of each satellite 12). If desired, scheduler 68 may schedule communications with UE devices 10 via satellites 12 based on the congestion levels identified by CLI 70 (e.g., using a load balancing scheme that helps to reduce the congestion level for satellites beams that exhibit a relatively high congestion level and/or that increases the congestion level for satellite beams that exhibit a relatively low congestion level in a manner that reduces latency for each of the served UE devices).

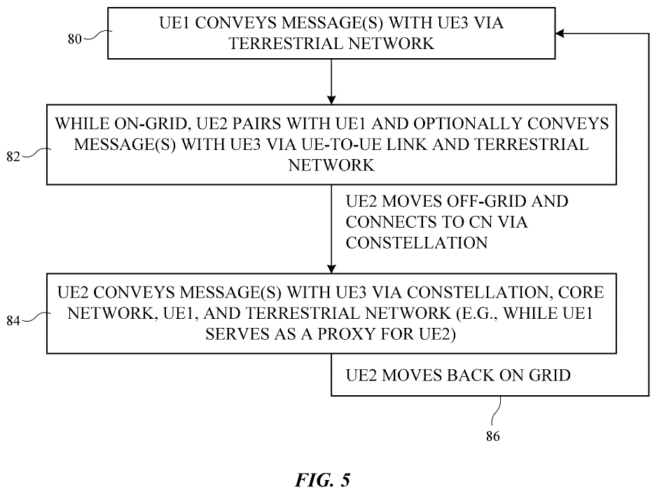

FIG. 5 is a flow chart of illustrative operations that may be performed by UE devices 10A and 10B of FIG. 1 for communicating with UE device 10C. At operation 80, UE device 10A may convey communications data with UE device 10C via terrestrial network 34 (e.g., via BS 21, carrier network 22, and/or CN 20). Implementations in which the communications data conveyed with UE device 10C includes text-based message data (e.g., one or more text-based messages such as SMS messages or text-based messages encoded using a non-SMS protocol) are described herein as an example. More generally, the messages conveyed between UE devices 10A, 10B, and 10C as described herein may include or be replaced with any desired communications data (e.g., internet browsing data, image data, video data, voice data, audio data, application data, email data, cloud data, etc.). UE device 10A may use its own credential, account, and/or subscription (e.g., SIM 53) for accessing carrier network 22 and/or CN 20 for conveying the messages with UE device 10C. Operation 80 may be omitted if desired.

At operation 82, while UE device 10B is within range of UE device 10A and/or on-grid (e.g., at location 6 in FIG. 1), UE device 10A may pair with or connect to UE device 10B. UE devices 10A and 10B may, for example, establish and maintain UE-to-UE link 4. UE device 10A may convey communications data with UE device 10B over UE-to-UE link 4. If desired, UE device 10B may optionally convey communications data such as one or more messages with UE device 10C via UE-to-UE link 4 and terrestrial network 34 (e.g., using UE device 10A as a relay device). In these implementations, UE device 10A may receive a message from UE device 10B over UE-to-UE link 4 and may store and process the message if desired (e.g., replacing identification information and/or subscription information in the message with its own identification information and/or subscription information). UE device 10A may use its own credential, SIM, and/or account to transmit (e.g., forward or relay) the message to BS 21 over terrestrial network wireless communication link 2. BS 21 may forward the message to carrier network 22. Carrier network 22 may forward the message to CN 20. CN 20 may forward the message to UE device 10C. Alternatively, BS 21 may forward the message directly to CN 20 without passing the message to carrier network 22. Additionally, or alternatively, UE device 10C may transmit communications data such as one or more messages destined for UE device 10A via CN 20, optionally carrier network 22, BS 21, and terrestrial network wireless communication link 2. UE device 10A may receive, store, and process the received message. UE device 10A may forward the message to UE device 10B over UE-to-UE link 4. This type of terrestrial relay-based communications via UE device 10A may be omitted while processing operation 82 if desired.

Processing may proceed from operation 82 to operation 84 if/when UE device 10B moves off grid and connects to CN 20 via constellation 32 (e.g., after moving in the direction of arrow 31 of FIG. 1). UE device 10B may connect (register) with CN 20 after transmitting reverse link signals carrying a registration (connection) request to CN 20 via constellation 32 and receiving a corresponding registration (connection) response (e.g., acknowledgment) from CN 20 via constellation 32, as one example. CN 20 may, if desired, compare identification information in the registration request to a subscriber list to determine that UE device 10B has subscribed to or is otherwise able to access satellite-based communications with CN 20 prior to transmitting the registration response.

At operation 84, UE device 10B may convey communications data (e.g., one or more messages) with UE device 10C via constellation 32, UE device 10A (e.g., serving as a relay and/or proxy device for UE device 10B), BS 21, and terrestrial network 34 (e.g., CN 20 and optionally carrier network 22). This may include, for example, the transmission of MO messages from UE device 10B to UE device 10C via constellation 32 and UE device 10A (e.g., as shown by arrows A1 and A2 of FIG. 1) and/or the transmission of MT messages from UE device 10C to UE device 10B via constellation 32 and UE device 10A (e.g., as shown by arrows A3 and A4 of FIG. 1). Once UE device 10B moves back on-grid, processing may loop back to operation 80 (as shown by arrow 86) or operation 82.

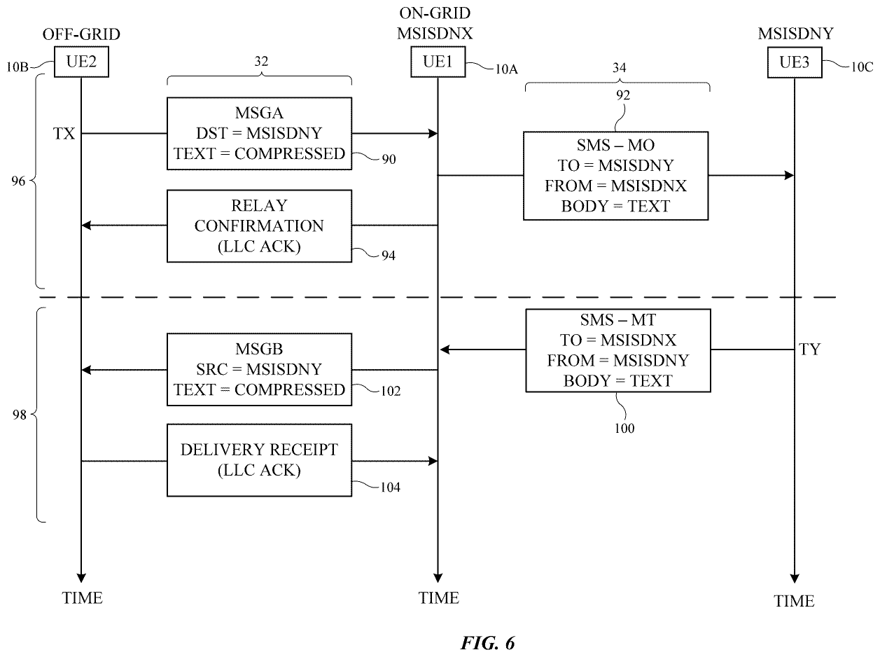

FIG. 6 is a timing diagram showing one high level example of how messages may be conveyed between UE device 10B and UE device 10C via constellation 32 and UE device 10A. The messages in FIG. 6 may be conveyed while processing operation 84 of FIG. 5, for example. Time is plotted on the vertical axis of FIG. 6. Portion 96 of FIG. 6 illustrates the transmission of a first message (MSGA) (e.g., an MO message) from an off-grid UE device 10B to UE device 10C via intervening UE device 10A. Portion 98 of FIG. 6 illustrates the transmission of a second message (MSGB) (e.g., an MT message) from UE device 10C to an off-grid UE device 10B via intervening UE device 10A. Portion 98 of FIG. 6 may occur prior to portion 96 of FIG. 6 if desired. Portion 96 or portion 98 may be omitted if desired.

As shown in FIG. 6, UE device 10B is off-grid beginning at time TX or earlier. UE device 10A is concurrently on-grid (e.g., as shown in FIG. 1). UE device 10A has corresponding identification and/or subscription information associated with the account for messaging service of the user of UE devices 10A and 10B. UE device 10A may, for example, have a corresponding MSIDN such as MSIDNX (e.g., associated with a SIM 53 on UE device 10A as shown in FIG. 2). UE device 10B may have a different corresponding MSIDN such as MSIDNY. This example is illustrative and non-limiting and, in general, any identifier or address information may be used to represent UE devices 10A and 10C.

At time TX, UE device 10B may transmit message 90 (MSGA) to UE device 10A via constellation 32, gateway 14, CN 20, and optionally carrier network 22. Message 90 may be a text-based message, as one example. Message 90 may, for example, have a data payload that includes text data (e.g., of a corresponding text message associated with a user input received by a user input device of UE device 10B). UE device 10B may generate, organize, and/or encode message 90 in or according to a first format (e.g., a non-SMS message format such as a satellite-based messaging format). The first format may, for example, serve to reduce or minimize the amount of data included in message 90 to accommodate the limited bandwidth of constellation 32 and/or may include redundancies, check fields, and/or other content that helps to ensure that the message is successfully received at CN 20 despite the limited bandwidth of constellation 32. If desired, the first format may accommodate advanced text messaging features such as tap backs, emojis, in-line replies, reactions, etc. If desired, the first format may also accommodate image data or other types of data (e.g., when constellation 32 has sufficient bandwidth to support this data).

UE device 10B may generate message 90 with a header that has a destination (DST) field (e.g., a receiver or recipient address field, sometimes also referred to herein as a “to” field) that includes, indicates, or otherwise identifies the intended recipient of message 90 (e.g., UE device 10C). The destination field may, for example, include, indicate, or otherwise identify identification information of UE device 10C such as the MSISDNY of UE device 10C. Message 90 may include a text-based data payload that is compressed and encrypted using a corresponding cryptographic key (e.g., the text data in message 90 may be compressed and encrypted according to the first format). Compressing the text of message 90 may, for example, help to minimize the bandwidth of the message for propagation through the bandwidth-limited constellation 32. If desired, the destination address field identifying UE device 10C may also be encrypted and/or compressed in message 90.

UE device 10A may receive message 90 from UE device 10B via constellation 32, gateway 14, CN 20, and optionally carrier network 22. UE device 10A may process and store the received message 90. If desired, UE device 10A may convert the received message 90 into a second format, as message 92, for transmission to UE device 10C over the terrestrial network. The second format may be, as one example, an SMS format (e.g., message 92 may be an SMS-MO message). UE device 10A may convert the format of message 90 by decrypting and decompressing the text-based data payload of message 90 (e.g., using a cryptographic key corresponding to the key used by UE device 10A to encrypt the text) and by inserting the decrypted and decompressed text in a payload field of message 92. UE device 10A may also include, add, or indicate, in a transmitter address field (sometimes also referred to herein as a source field, a source address field, or a “from” field), its own identification information. For example UE device 10A may include its own MSISDNX in the transmitter address field. If desired, UE device 10A may replace information identifying UE device 10B in the transmitter address field of message 90 while generating message 92. The body (data payload) of message 92 may include the decompressed and decrypted text from the body/payload of message 90. The recipient address field of message 92 (e.g., a “to” header field of message 92) may still include, indicate, or otherwise identify the MSISDNY of UE device 10C.

If desired, UE device 10A may check whether an off the grid (OTG) relay mode is enabled at UE device 10A. A user may, for example, provide a user input that effectively enables or disables the OTG relay mode. If/when the OTG relay mode is enabled, UE device 10A may transmit message 92 to UE device 10C via terrestrial network 34 (e.g., via BS 21, CN 20, and/or carrier network 22). If/when UE device 10A is a companion device to UE device 10B, UE device 10A may us its own SIM 53 to transmit message 92 to UE device 10C via the corresponding carrier network 22. In this way, UE device 10A may relay the message 90 transmitted by UE device 10A in the first format to UE device 10C in the second format (as message 92). UE device 10C may receive message 92 and may display the contents of message 92 on a display of UE device 10C (e.g., using a messaging application running on UE device 10C). If desired, UE device 10A may forego relay for UE device 10B when the OTG relay mode is disabled.

UE device 10A may also transmit a relay confirmation 94 to UE device 10A over BS 21, optionally carrier network 22, CN 20, gateway 14, and constellation 32 after, upon, or in response to transmitting message 92 to UE device 10C. The relay confirmation may, for example, include an LLC ACK message that is received at UE device 10B. Relay confirmation 94 (sometimes also referred to herein as relay confirmation message 94) may serve to inform UE device 10B that UE device 10A successfully relayed the message 90 transmitted by UE device 10B to UE device 10C. If desired, UE device 10B may display a graphical indicator and/or text on a display (e.g., using a messaging application running on UE device 10B) that indicates or serves to inform the user of UE device 10B that the transmitted message 90 was successfully relayed to UE device 10C.

Conversely, at time TY (e.g., after or responsive to receipt of message 92), UE device 10C may generate and transmit message 100 to UE device 10A over terrestrial network 34 (e.g., CN 20 and optionally carrier network 22) and BS 21. UE device 10C may transmit message 100 using the second format (e.g., in an SMS format, as an SMS-MT message). UE device 10C may include or indicate its own identification information (e.g., MSISDNY) in a transmitter address header field of message 100. UE device 10C may include or indicate the identification information of UE device 10A (e.g., MSISDNX, as identified from the transmitter address field in the message 92 received from UE device 10A) in a receiver address header field of message 100. The body (payload) of message 100 may include text.

UE device 10A may receive message 100 from UE device 10C via terrestrial network 34. UE device 10A may process and store the received message 100. UE device 10A may, for example, check whether the OTG relay mode is enabled. If/when the OTG relay mode is enabled, UE device 10A may relay message 100 to UE device 10B via constellation 32, as message 102 (MSGB) in the first format. UE device 10A may, for example, generate message 102 by compressing and encrypting the text body of message 100 and inserting the compressed and encrypted text body in message 102. Message 102 may have a header with a source (SRC) field that includes, indicates, or identifies the UE device 10C that transmitted message 100 (e.g., the MSISDNY of UE device 10C). UE device 10A may transmit message 102 to UE device 10B over BS 21, optionally carrier network 22, CN 20, gateway 14, and constellation 32.

UE device 10B may receive message 90 (in the first format) from UE device 10A via constellation 32. UE device 10B may process and store the received message 90. For example, UE device 10B may decrypt and decompress the text body of message 102. If desired, UE device 10B may display the text body of message 102 on a display 51 of UE device 10B (FIG. 2). The SRC field of message 102 and/or a message identifier field may help UE device 10B to identify that message 102 was transmitted by UE device 10C in response to its earlier-transmitted message 90 and/or as a part of the same text messaging thread. UE device 10B may transmit a delivery receipt message 104 to UE device 10A via constellation 32, gateway 14, CN 20, optionally carrier network 22, and BS 21 responsive to receipt of message 102. Delivery receipt message 104 may include, for example, an LLC ACK that is received by UE device 10A. Delivery receipt message 104 (sometimes also referred to herein as delivery receipt 104) may serve to inform UE device 10A that UE device 10A successfully relayed the message 100 transmitted by UE device 10C to UE device 10A. In this way, UE device 10B may use the credentials of UE device 10A and/or may utilize UE device 10A as a relay to perform messaging with UE device 10C without carrier network 22 and/or UE device 10C having knowledge that communications are being performed via constellation 32 (e.g., because UE device 10B serves as a proxy for UE device 10A, from the perspective of carrier network 22 and UE device 10C, UE device 10C and carrier network 22 are conveying messages with UE device 10B via the terrestrial network).

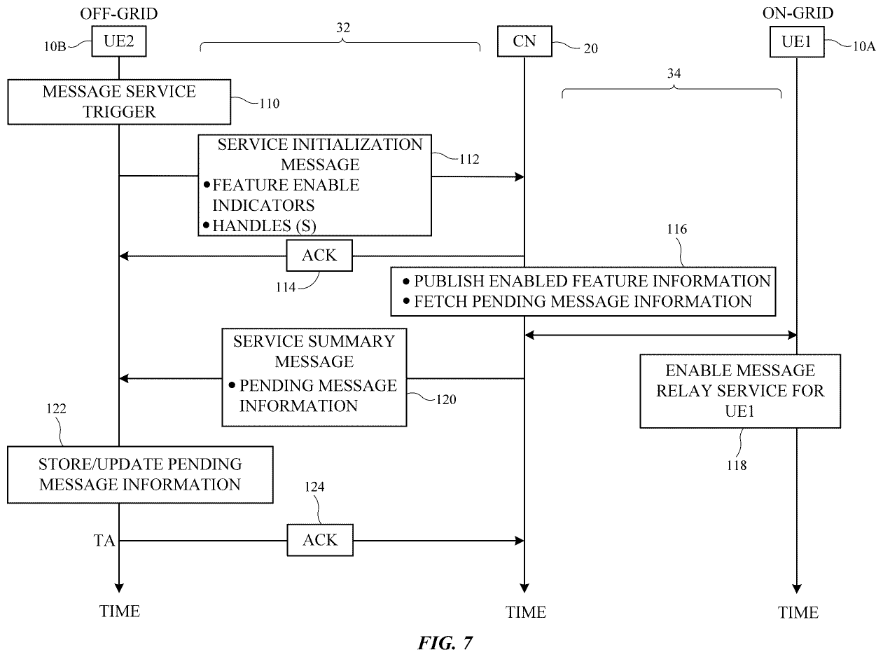

The messages of FIG. 6 may be conveyed after a satellite messaging service initialization procedure has been performed by UE device 10B, CN 20, and/or UE device 10A. FIG. 7 is a timing diagram illustrating one example of a satellite messaging service initialization procedure that may be performed prior to message relay by UE device 10A. The operations of FIG. 7 may be performed after UE device 10B has gone off-grid and registered with CN 20 for satellite communications services (e.g., between operations 82 and 84 of FIG. 5).

As shown in FIG. 7, a message service trigger 110 may occur at UE device 10B. The message service trigger may be, for example, an input received at a user input of UE device 10B (e.g., that serves to open a satellite-based messaging application on UE device 10A, that includes message text to send to UE device 10C, that indicates to a satellite-based messaging application that the user has a message or is entering a message to transmit via constellation 32, that indicates to software on UE device 10B that the user wishes to communicate via constellation 32, etc.), another application or API call, a calendar or scheduled trigger, activation or use of an emergency service application or feature running on UE device 10B, or any other desired trigger condition that triggers the use of UE device 10B to communicate via constellation 32 (e.g., with UE device 10A as a relay device, such as when UE device 10B does not its own separate SIM).

UE device 10B may transmit (e.g., responsive to message service trigger 110) a service initialization message 112 to CN 20 via constellation 32 and gateway(s) 14 (e.g., in one or more reverse link transmissions). If desired, service initialization message 112 may include one or more feature enable indicators. The feature enable indicators (sometimes also referred to as feature enablement indicators) may indicate or identify one or more wireless communications features that are enabled at UE device 10B. The feature enable indicators may include a status indicator identifying an operating status or condition of UE device 10B (e.g., identifying whether UE device 10B is in a wake mode, a sleep mode, a focus mode, a do not disturb mode, an active mode, is able to receive satellite-based messages, is able to transmit satellite-based messages, is off-grid, etc., identifying that UE device 10B is running a satellite-based messaging application, identifying a battery status of UE device 10B, identifying a communications service level enabled at or supported by UE device 10B, etc.). If desired, service initialization message 112 may include, identify, or indicate a corresponding token. If desired, service initialization message 112 may include, identify, or indicate one or more handles. The handles may be associated with a corresponding user account, subscription, carrier, SIM, MSISDN, email address, etc., (e.g., one or more handles of UE device 10B, of UE device 10A, of UE device 10C, associated with the user of UE devices 10B and 10A, associated with the user of UE device 10C, etc.). If desired, the handles may be shorter than a full user account identifier, MSISDN, email, etc., to help reduce the bandwidth consumed by service initialization message 112. The handles are therefore sometimes also referred to herein as short handles. Service initialization message 112 may serve to inform CN 20 that UE device 10B is ready to begin using the satellite communications services of CN 20 for subsequent message communication (e.g., indicating to CN 20 that UE device 10B has one or more text messages to transmit to UE device 10C, indicating to CN 20 that UE device 10B is requesting delivery of any pending or future messages transmitted by UE device 10C, etc.).

CN 20 may transmit an acknowledgment (ACK) message 114 to UE device 10B via gateway(s) 14 and constellation 32 in response to receiving and successfully decoding service initialization message 112. ACK message 114 may include an LLC ACK, as one example. After transmitting ACK message 114, at operation 116, CN 20 may store and/or publish enabled feature information associated with and/or indicated/identified by the service initialization message 112 received from UE device 10B. For example, CN 20 may advertise, to UE device 10A, UE device 10C, and/or other authorized UE devices (e.g., using a pushed message or upon receipt of a query by the other device), the current status of UE device 10B, information indicating that UE device 10B is able to transmit and/or receive satellite-based messages, information indicating that UE device 10B is operating in a focus mode, etc. If desired, CN 20 may also fetch (e.g., identify and/or read from storage) pending message information for UE device 10B, UE device 10A, and/or the user of UE devices 10A and 10B. The pending message information may include a pending message count and/or one or more pending messages (e.g., messages that have been received from other network nodes or devices for transmission to UE device 10A, UE device 10B, and/or the user of UE devices 10A and 10B but that have not yet been delivered).

If desired, CN 20 may transmit a summary of the pending messages that CN 20 has for UE device 10A, UE device 10B, and/or the user of UE devices 10A. The summary may identify the pending message count and/or other information about the pending messages (e.g., timestamp information, sender information, etc.). CN 20 may transmit this summary to UE device 10B (e.g., via the constellation), UE device 10A (e.g., via the terrestrial network), and/or to other UE devices associated with the same user account as UE devices 10A and 10B (e.g., using a fanout scheme). If desired, CN 20 may transmit the summary if/when there are more than a threshold number of pending messages queued for delivery (e.g., three or more pending messages) and may forego transmitting the summary if/when there are less than the threshold number of pending messages queued for delivery.

For example, as shown in FIG. 7, CN 20 may transmit a service summary message 120 to UE device 10B via gateway(s) 14 and constellation 32. Service summary message 120 may include, indicate, and/or identify the pending message information (e.g., as fetched at operation 116). If desired, service summary message 120 may include one or more handles and/or pending message counts associated with UE device 10A, UE device 10B, and/or the user of UE devices 10A and 10B. As an example, service summary message 120 may identify a count of pending SMS messages and/or non-SMS messages stored at CN 20 for delivery to the user or account associated with UE devices 10A and 10B.

If desired, at operation 118, UE device 10A may enable message relay service for UE device 10A. For example, UE device 10A may receive a user input that places UE device 10A in an off-the-grid (OTG) mode and/or a relay mode (e.g., as set prior to the user moving away from UE device 10A with UE device 10B), may run an application that places UE device 10A in an OTG mode and/or a relay mode, etc. If desired, UE device 10A may enable OTG mode and/or relay mode in response to receiving the enable feature information published by CN 20 at operation 116. Operation 118 may be omitted if desired.

At operation 122, UE device 10B may receive and store service summary message 120. UE device 10B may store the pending message information from service summary message 120. If desired, UE device 10B may update pending message information already stored on UE device 10B (e.g., pending message counts, handles, etc.) based on the pending message information received in service summary message 120. As one example, UE device 10B may update a count of pending SMS messages that are stored at CN 20 for delivery to the user of UE device 10B and/or a count of pending non-SMS messages that are stored at CN 20 for delivery to the user of UE device 10B. In this way, UE device 10B may have current information about the pending messages that CN 20 has queued or stored for delivery to UE device 10A, UE device 10B, and/or the user associated with UE devices 10A and 10B.

At time TA (e.g., responsive to receipt of service summary message 120), UE device 10B may transmit an ACK message 124 (e.g., an LLC ACK) to CN 20 via constellation 32 and gateway(s) 14. ACK message 124 may serve to inform CN 20 that UE device 10B successfully received service summary message 120. After time TA, UE device 10B is ready to convey messages with UE device 10C via CN 20 using UE device 10A as a relay.

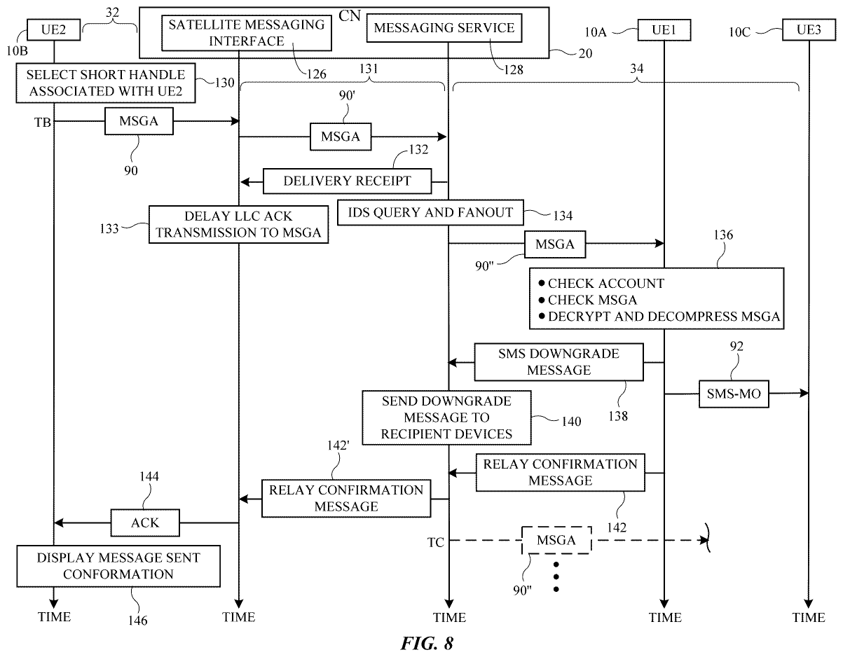

FIG. 8 is a timing diagram illustrating one example of how UE device 10B may transmit a message (e.g., an MO message such as the message MSGA of FIG. 6) to UE device 10C via constellation 32, CN 20, and relay by UE device 10A. The messaging and operations of FIG. 8 may, for example, be conveyed and/or processed during portion 96 of FIG. 6, for example.

As shown in FIG. 8, CN 20 may include one or more servers that process messages conveyed by UE devices 10A and/or 10B. CN 20 may include, for example, a satellite messaging interface 126 (e.g., one or more satellite messaging servers, a satellite messaging service cloud region, a satellite messaging service of CN 20, etc.) and a messaging service 128 (e.g., one or more messaging servers, a messaging service cloud region, etc.). Messaging service 128 may provide messaging services via terrestrial network 34 and/or constellation 32 to UE devices that are connected and/or subscribed to CN 20 for messaging services. Satellite messaging service 126 may form a communications interface with constellation 32 and gateway(s) 14 for messaging service 128 (e.g., satellite messaging service 126 may manage and control satellite-based messaging via constellation 32 and messaging service 128 may provide corresponding terrestrial network messaging services). This is illustrative and non-limiting and, in practice, the operations of satellite messaging service 126 and messaging service 128 may be divided between one or more cloud regions and/or servers of CN 20.

If desired, at operation 130, UE device 10B may select a short handle associated with the UE device 10A that UE device 10B will use for relaying satellite-based messages. The short handle may, for example, correspond to the paired phone number, SIM, or MSISDN of UE device 10A that UE device 10B intends to send text messages from and/or to receive text messages at. UE device 10B may select the short handle based on a user input received at a user input device of UE device 10B and/or using one or more software applications running on UE device 10B.

At time TB, which may be after time TA of FIG. 7, UE device 10B may transmit message 90 to CN 20 via constellation 32 and gateway(s) 14. CN 20 may receive message 90 at satellite messaging interface 126. If desired, UE device 10B may include, identify, or indicate the selected short handle (e.g., the paired phone number, SIM, MSISDN, identifier, and/or credential of UE device 10A) in the transmitted message 90 (e.g., in one or more header fields). UE device 10B may, for example, indicate the same short handle of UE device 10A in both “to” (destination) and “from” (source) handle fields of message 90. This may, for example, serve to trigger CN 20 to relay message 90 to UE device 10A after receipt. UE device 10B may compress and encrypt the payload (text body) of message 90 prior to transmission. The destination (recipient) address field of message 90 may indicate or identify the intended recipient UE device 10C (e.g., may include or indicate the MSISDNY of UE device 10C as shown in FIG. 6). If desired, UE device 10B may also compress and/or encrypt the destination address field of message 90.

Satellite messaging interface 126 may transmit the received message 90 to messaging service 128 via communications channel 131, as message 90′. Communications channel 131 may be, for example, an internal network channel of CN 20 between satellite messaging interface 126 and messaging service 128. If desired, satellite messaging interface 126 may include, in message 90′, a message identifier associated with message 90, a satellite identifier (e.g., identifying that message 90 was received via satellite and/or identifying the satellite(s) 12 in constellation 32 that relayed the message), an expiration timer, one or more cryptographic keys, and/or any other desired information.

Messaging service 128 may transmit a delivery receipt 132 to satellite messaging interface 126 over communications channel 131 in response to receiving message 90′. Delivery receipt 132 may confirm to satellite messaging interface 126 that message 90′ was successfully delivered to and received by messaging service 128. Delivery receipt 132 may control satellite messaging interface 126 to at least temporarily delay or forego LLC ACK transmission to message 90 by satellite messaging interface 126 (at operation 133). If desired, delivery receipt 132 may serve to stop satellite messaging interface 126 from retransmitting message 90′ to messaging service 128.

At operation 134, messaging service 128 may perform an identity service (IDS) query with an IDS of CN 20 (not shown). The IDS query may have a “to” field and a “from” field that are both set equal to the SIM, identifier, or MSISDN of UE device 10A (as identified in message 90). If desired, messaging service 128 and/or the IDS may perform a fanout for message 90. The fanout may identify a set of UE devices associated with UE devices 10A and 10B and/or that are logged into the same messaging/user account as the user of UE devices 10A and 10B. Fanout may also involve the eventual distribution of message 90 and/or other messages transmitted and/or received by UE device 10B to the UE devices in the identified set.

Messaging service 128 may forward, relay, route, or transmit message 90′ to UE device 10A over terrestrial network 34 (e.g., carrier network 22 and BS 21 of FIG. 1), as message 90″. If desired, message 90″ may be in the same format as message 90 or may be in a different format (e.g., a format that is less bandwidth constrained than the format of message 90). If desired, CN 20 may transmit message 90″ without decrypting and/or decompressing the payload (message body) of message 90. Message 90″ may also include, indicate, or identify the short handle included in message 90 by UE device 10B (e.g., the phone number, identifier, credential, SIM, or MSISDN of UE device 10A).

UE device 10A may receive message 90″ from CN 20 over terrestrial network 34. At operation 136 (e.g., responsive to receipt of message 90″), UE device 10A may check (verify) whether the account associated with the user of UE devices 10A and 10B is in the OTG mode (e.g., as enabled at operation 118 of FIG. 7). UE device 10A may also check the (verify) whether the short handle in message 90″ (e.g., the phone number, SIM, or MSISDN included in message 90″) is associated with (e.g., owned by) a SIM of UE device 10A. If/when the short handle is associated with UE device 10A and UE device 10A is in OTG mode, UE device 10A may decompress and decrypt the payload (message body) of message 90″. If desired, UE device 10A may also decrypt and decompress the destination address field of message 90″.

UE device 10A may then generate SMS-MO message 92 based on the decompressed and decrypted message 90″. UE device 10A may, for example, generate SMS-MO message 90 in the second format (e.g., an SMS format or another messaging format different from the first format used to transmit message 90 over constellation 32). UE device 10A may include the decompressed and decrypted payload (text body) of message 90″ in the payload (text body) of SMS-MO message 92. SMS-MO message 92 may have a “to” header field that includes, indicates, or identifies UE device 10C (e.g., that includes the MSISDNY of UE device 10C of FIG. 6) and may have a “from” header field that includes, indicates, or identifies UE device 10A (e.g., that includes the MSISDNX of UE device 10A of FIG. 6). UE device 10A may transmit SMS-MO message 90 to UE device 10C via terrestrial network 34 (e.g., via BS 21 and the carrier network 22 associated with the SIM of UE device 10A). If/when the short handle is not associated with UE device 10A and/or UE device 10A is not in OTG mode, UE device 10A may discard message 90″ or may store message 90″ for later processing and/or delivery.

If desired, UE device 10A may transmit an SMS downgrade message 138 to messaging service 128 of CN 20 over terrestrial network 34 before, after, or concurrent with transmission of SMS-MO message 92. SMS downgrade message 138 may, for example, trigger messaging service 128 to perform operation 140. At operation 140, messaging service 128 may transmit an SMS downgrade message to one or more recipient devices. The recipient devices may be UE devices associated with the user of UE devices 10A and 10B, devices associated with contacts or accounts stored in a contact list of the user account associated with UE devices 10A and 10B, intended recipients of messages from UE devices 10A and/or 10B, etc. The SMS downgrade message may, for example, instruct the recipient devices to downgrade subsequent messages transmitted to the user account of UE devices 10A and 10B to a lower bandwidth format such as an SMS format (e.g., removing multimedia or other high bandwidth features from the messages). This may help the subsequent messages to be successfully conveyed over the limited bandwidth of constellation 32 without informing the recipient devices that the recipient devices are communicating with UE device 10B or over constellation 32.

After transmitting SMS-MO message 92, UE device 10B may transmit relay confirmation message 142 to messaging service 128 of CN 20. Relay confirmation message 142 may serve to confirm, to CN 20, that UE device 10A successfully relayed message 90 (as SMS-MO message 92) to its intended recipient via the terrestrial network (e.g., to UE device 10C). If desired, relay confirmation message 142 may include a message identifier field that indicates the same message identifier included by CN 20 in message 90′ (e.g., informing CN 20 of the particular message that was relayed). Messaging service 128 may then forward relay confirmation message 142 to satellite messaging interface 126 over communications channel 131 (as relay confirmation message 142′). Relay confirmation messages 142 and 142′ are sometimes also referred to herein simply as relay confirmations 142 and 142′. Satellite messaging interface 126 may generate an ACK message 144 (e.g., an LLC ACK) based on relay confirmation message 142′. ACK message 144 may be in the first format. Satellite messaging interface 126 may transmit ACK message 144 to UE device 10B via gateway(s) 14 and constellation 32. ACK message 144 and relay confirmation messages 142 and 142′ may collectively form relay confirmation 94 of FIG. 6, for example.

UE device 10B may receive and store ACK message 144. At operation 146 (e.g., responsive to receipt of ACK message 144), UE device 10B may display a message sent confirmation on its display (e.g., display 51 of FIG. 2). For example, a satellite-based messaging application running on UE device 10B may cause display 51 to display a message sent confirmation in a graphical user interface (e.g., next to a text field that displays the text content of the transmitted message 90). This may serve to inform the user of UE device 10B that the message was successfully transmitted to its intended recipient (e.g., UE device 10C) via satellite using the SIM or other credentials of UE device 10A.

If desired, at time TC, messaging service 128 may transmit message 90″ to one or more UE devices other than UE devices 10A and 10B (e.g., UE devices associated with the same account as UE devices 10A and 10B). This may effectively fan out message 90″ to each of the user's devices (e.g., synchronizing the message thread between the user of UE device 10B and UE device 10C across the user's other UE devices). If/when another UE device of the user receives message 90″, that UE device will not relay message 90″ to UE device 10C (e.g., because that UE device does not have OTG mode enabled, because that UE device does not have the same SIM as UE device 10A and as identified in message 90, etc.).

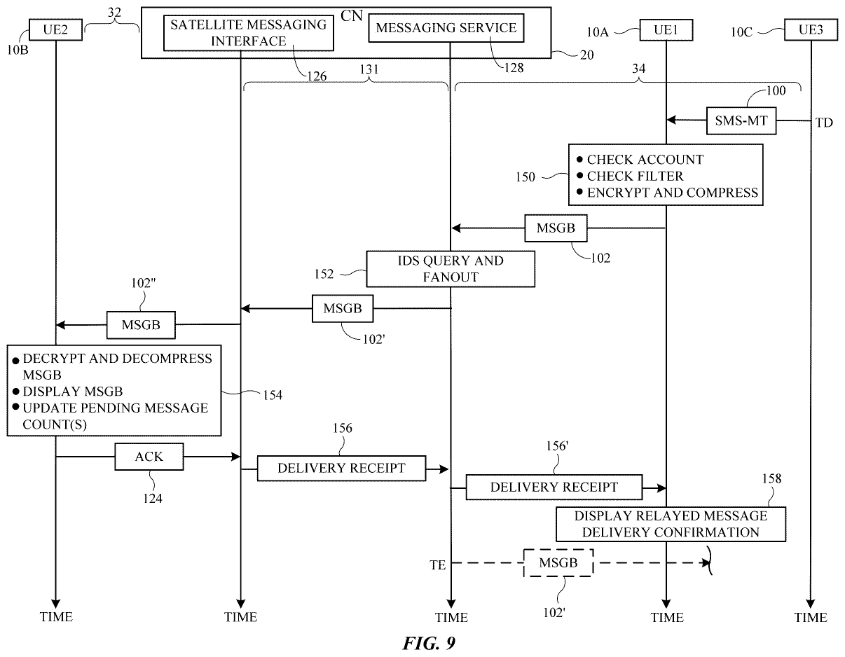

FIG. 9 is a timing diagram illustrating one example of how UE device 10B may receive a message (e.g., an MT message such as message MSGB of FIG. 6) from UE device 10C via constellation 32, CN 20, and relay by UE device 10A. The messaging and operations of FIG. 9 may, for example, be conveyed and/or processed during portion 98 of FIG. 6.

As shown in FIG. 9, at time TD (e.g., after time TA of FIG. 7), UE device 10C may transmit SMS-MO message 100 to UE device 10A over terrestrial network 34. UE device 10C may transmit SMS-MO message 100 using the second format (e.g., as an SMS message). SMS-MO message 100 may have a header with a “to” (destination address) field that indicates, includes, or identifies the MSISDNX of UE device 10A and with a “from” (source address) field that indicates, includes, or identifies the MSISDNY of UE device 10C.

At operation 150 (e.g., responsive to receipt of SMS-MO message 100), UE device 10A may check whether the account associated with the user of UE devices 10A and 10B is in the OTG mode (e.g., as enabled at operation 118 of FIG. 7). UE device 10A may also check whether SMS-MO message passes a message filter applied at UE device 10A. The message filter may include one or more policies dictating which UE devices are able to communicate with UE device 10B via constellation 32. The policies may be set by the user of UE devices 10A/10B, one or more software applications, and/or CN 20. The policies may, for example, allow CN 20 to limit traffic over the bandwidth constrained constellation 32 and/or may allow a user to limit who is able to message their UE devices via the resources of constellation 32 while off-grid (e.g., to prevent the user from depleting messaging/bandwidth allocations associated with their subscription to services with CN 20, to minimize subscription or per-message costs for the user, etc.).

As one example, UE device 10A may store and maintain a list of contacts. A set of the contacts (e.g., some or all of the total contact list of UE device 10A and/or the account associated with UE device 10A) may form contacts that the user allows to communicate with their UE devices via constellation 32. This set of contacts is sometimes also referred to herein as a trusted contacts list, a close contacts list, or a primary contacts list of the user's account, of UE device 10A, and/or of UE device 10B. The primary contacts list may, for example, effectively form a filter of UE devices that are allowed/able to communicate with UE device 10B via constellation 32. If/when SMS-MT message 100 was transmitted by a contact included on the list (e.g., if/when UE device 10C and/or an account associated with UE device 10C are on the list), UE device 10A may relay SMS-MT message 100 to UE device 10B. If/when SMS-MT message 100 was transmitted by an entity other than a contact on the list (e.g., if/when UE device 10C and/or the account associated with UE device 10C are not on the list), UE device 10A may forego relaying the message to UE device 10B. Additionally, or alternatively, the filter may specify that a UE device that previously received an MO message transmitted by UE device 10B and/or UE device 10A via constellation 32 (e.g., within a predetermined time period, during the current registration/session of UE device 10B with constellation 32, etc.) is allowed to transmit MO messages to UE device 10B via constellation 32 (e.g., under the assumption that the user transmitting a message to a particular device via constellation 32 acts as an implicit approval of receiving messages from that same device via constellation 32).

If/when the received SMS-MT message 100 passes the filter and the OTG mode is enabled, UE device 10A may encrypt and compress the payload (text/message body) of SMS-MT message 100. UE device 10A may insert the encrypted and compressed payload into the payload (body) of message 102 (e.g., MSGB). If desired, UE device 10A may include, in message 102, the short handle of UE device 10A (e.g., the SIM, MSISDN, and/or phone number of UE device 10A) that was utilized by UE device 10A to receive SMS-MT message 100. Message 102 may have a destination address field that identifies, includes, or indicates an address of UE device 10B and may have a source address field that indicates, identifies, or includes the MSISDNY of the UE device 10C that transmitted the corresponding SMS-MT message 100. If desired, UE device 10A may also encrypt and compress the source address field of message 102. SMS-MT message 100 and/or message 102 may also include a corresponding time stamp field associated with a time when UE device 10C transmitted SMS-MO message 100.

UE device 10A may generate message 102 using the first format (e.g., a non-SMS message format or another text-based messaging format suitable for transmission over constellation 32). If desired, UE device 10A may insert a message identifier in message 102 that identifies SMS-MT message 100. Put differently, UE device 10A may convert SMS-MT message 100 from the second format into the first format (as message 102). UE device 10A may transmit message 102 to messaging service 128 of CN 20 over terrestrial network 34.

At operation 152 (e.g., responsive to receipt of message 102 from UE device 10A), messaging service 128 may perform an IDS query and fanout based on message 102 (see, e.g., operation 134 of FIG. 8). Messaging service 128 may forward message 102 to satellite messaging service 126 over communications channel 131. Satellite messaging service 126 may transmit message 102′ to UE device 10B via gateway(s) 14 and constellation 32 (as message 102″). Messages 102, 102′, and 102″ may include the message identifier associated with the SMS-MT message 100 received by UE device 10 (e.g., associating messages 102, 102′, and 102″ with a particular SMS-MT message 100). The message 102″ transmitted by satellite messaging service 126 may include or indicate the short handle of UE device 10A (e.g., the SIM, MSISDN, and/or phone number of UE device 10A) that was utilized by UE device 10A to receive SMS-MT message 100.

UE device 10B may receive message 102″ via constellation 32. At operation 154 (e.g., responsive to receipt of message 102″), UE device 10B may decrypt and decompress message 102″. UE device 10B may display the decrypted body of message 102″ and, if desired, a corresponding time stamp. UE device 10B may display a graphical indicator indicating that the received message 102″ was transmitted by UE device 10C and/or MSISDNY (e.g., based on the source address field of message 102″). If desired, UE device 10B may also update its pending message count(s) based on the received message 102″ (e.g., removing message 102″ from a count of pending messages when applicable). The updated message count(s) may include a pending SMS count and/or a pending total messages count (e.g., identifying the total number of pending messages of any format).

In response to receiving message 102″, UE device 10B may transmit ACK message 124 (e.g., an LLC ACK) to satellite messaging service 126 via constellation 32 and gateway(s) 14. Satellite messaging service 126 may transmit a corresponding delivery receipt 156 to messaging service 128 over communications channel 131. Messaging service 128 may transmit a corresponding delivery receipt 156′ to UE device 10A over terrestrial network 34. ACK message 124, delivery receipt 156, and delivery receipt 156′ may collectively form delivery receipt 104 of FIG. 6. ACK message 124, delivery receipt 156, and delivery receipt 156′ may each include or indicate the message identifier of SMS-MO 100 and messages 102, 102′, and 102″. This may indicate, to UE device 10A, the particular SMS-MO message that UE device 10A successfully relayed to UE device 10B over satellite. UE device 10A may store the delivery receipt and may use the delivery receipt to know that the message 100/102 previously relayed by UE device 10A was successfully received at UE device 10B via satellite. At operation 158 (e.g., responsive to receiving delivery receipt 156′), if desired, UE device 10A may display a message delivery confirmation associated with successful delivery of message 100/102 to UE device 10B (e.g., a relayed message delivered notification or graphical indicator).

If desired, at time TE, messaging service 128 may transmit message 102 to one or more UE devices other than UE devices 10A and 10B (e.g., UE devices associated with the same account as UE devices 10A and 10B). This may effectively fan out message 102 to each of the user's devices (e.g., synchronizing the message thread between the user of UE device 10B and UE device 10C across the user's other UE devices). If/when another UE device of the user receives message 102, that UE device will not relay message 102 to UE device 10C (e.g., because that UE device does not have OTG mode enabled). The example of FIGS. 6-9 is illustrative and non-limiting. In general, other signal transmission schemes and timings may be used.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

One or more elements described herein (e.g., UE devices 10, satellite 12, gateway 14, CN 20, etc.) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-9 may be performed using software, firmware, and/or hardware (e.g., dedicated circuitry or hardware). Software code for performing these operations may be stored on non-transitory computer readable storage media (e.g., tangible computer readable storage media) stored on one or more of the components of communications system 38 (e.g., storage circuitry 46 of FIG. 2 or similar storage circuitry on satellites 12, gateways 14, CN 20, network portion 18, etc.). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of communications system 38 (e.g., processing circuitry 48 of FIG. 2 or similar processing circuitry on satellites 12, gateways 14, CN 20, network portion 18, etc.). The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A method of operating a first user equipment (UE) device, the method comprising:
connecting to a core network via a constellation of communication satellites; and
transmitting a message to a second UE device via the constellation, the core network, and relay by a third UE device that is associated with the first UE device, wherein the message comprises
a handle associated with a subscriber identity module (SIM) of the third UE device, and
a destination address associated with the second UE device.

2. The method of claim 1, further comprising:
receiving, from the third UE device via the core network and the constellation, a relay confirmation message indicative of the third UE device relaying the message to the second UE device.

3. The method of claim 1, wherein the message comprises a text payload and the method further comprises:
compressing and encrypting the text payload.

4. The method of claim 3, further comprising:
compressing and encrypting the destination address.

5. The method of claim 4, wherein the destination address comprises a Mobile Station International Subscriber Directory Number (MSISDN) of the second UE device.

6. The method of claim 1, wherein the handle is included in both a source handle field and a destination handle field of the message.

7. The method of claim 1, further comprising:
transmitting, to the core network via the constellation, a service initialization message after connecting to the core network via the constellation, wherein the service initialization message identifies one or more communication features that are enabled at the first UE device; and
receiving, from the core network via the constellation, a service summary message after transmitting the service initialization message and prior to transmitting the message, wherein the service summary message identifies a count of pending messages stored at the core network for delivery to the first UE device.

8. The method of claim 1, further comprising:
transmitting, prior to connecting to the core network via the constellation, an additional message to the third UE device via a UE-to-UE link, wherein the third UE device relays the additional message to the second UE device via a wireless base station and a carrier network, and wherein connecting to the core network via the constellation comprises connecting to the core network via the constellation while the first UE device is unable to connect to the carrier network, the wireless base station, and the third UE device.

9. The method of claim 8, wherein the UE-to-UE link comprises a Wireless Personal Area Network (WPAN) link, a Wireless Local Area Network (WLAN) link, or a Device-to-Device (D2D) link.

10. The method of claim 1, further comprising:
receiving, via the constellation, the core network, and relay by the third UE device, an additional message transmitted by the second UE device, wherein the received additional message comprises the handle and a source address associated with the second UE device.

11. A method of operating a first user equipment (UE) device, the method comprising:
receiving, from a core network, a message that was transmitted by a second UE device to the core network over a constellation of communication satellites; and
relaying, using a subscriber identity module (SIM) of the first UE device, the message to a third UE device via a wireless base station and a carrier network, the carrier network being associated with the SIM of the first UE device.

12. The method of claim 11, wherein the message is received from the core network in a first format and the method further comprises:
converting the message from the first format into a second format, wherein the first UE device relays the message to the third UE device in the second format.

13. The method of claim 12, further comprising:
decompressing and decrypting a text body of the message received from the core network; and
including the decompressed and decrypted text body in a payload of the message that is relayed to the third UE device, wherein the second format comprises a Short Message Service (SMS) format and wherein the first format comprises a non-SMS message format.

14. The method of claim 11, further comprising:
receiving, from the second UE device prior to receiving the first message, an additional message transmitted by the second UE device over a UE-to-UE link; and
relaying, using the SIM of the first UE device, the additional message to the third UE device via the wireless base station and the carrier network.

15. The method of claim 11, further comprising:
receiving, from the third UE device via the carrier network and the wireless base station, a Short Message Service (SMS) message using the SIM of the first UE device;
encrypting and compressing a text body of the SMS message;
generating an additional message having a data payload that includes the encrypted and compressed text body;
transmitting the additional message to the second UE device via the core network and the constellation; and
receiving, from the second UE device via the constellation and the core network, a delivery receipt associated with receipt of the additional message at the second UE device.

16. The method of claim 15, further comprising:
comparing a source address field of the received SMS message to a contact list associated with communication with the first UE device via the constellation; and
encrypting and compressing the text body in response to the source address field matching a contact on the contact list.

17. The method of claim 12, further comprising:
transmitting, to the second UE device via the core network and the constellation, a relay confirmation message indicative of the first UE device relaying the message to the third UE device.

18. A method of operating one or more servers of a core network, the method comprising:
receiving a message from a first user equipment (UE) device via a constellation of communications satellites, wherein software on the first UE device is logged into an account associated with the core network;
forwarding the message to a second UE device via a terrestrial network, wherein software on the second UE device is logged into the account associated with the core network; and
receiving a relay confirmation message from the second UE device via the terrestrial network, wherein the relay confirmation message is indicative of the second UE device relaying the message to a third UE device that is different from the first and second UE devices.

19. The method of claim 18, further comprising:
transmitting, to the first UE device via the constellation, an acknowledgment message associated with the relay confirmation message.

20. The method of claim 18, further comprising:
receiving, via relay by the second UE device, an additional message transmitted by the third UE device; and
forwarding the additional message to the first UE device via the constellation.
